(19) United States
(12) Patent Application Publication
(10) Pub. No.: US 2026/0081673 A1
(43) Pub. Date: Mar. 19, 2026

(54) TIMING ADVANCE DETERMINATION FOR PHYSICAL UPLINK CONTROL CHANNEL MESSAGE WITH LINK RECOVERY REQUEST

(71) Applicant: QUALCOMM Incorporated, San Diego, CA (US)

(72) Inventors: Shaozhen GUO, Beijing (CN); Mostafa KHOSHNEVISAN, San Diego, CA (US)

(21) Appl. No.: 19/109,080

(22) PCT Filed: Oct. 31, 2022
(86) PCT No.: PCT/CN2022/128533

§ 371 Date: Mar. 5, 2025

(51) Int. Cl. H04B 7/06; H04L 5/00; H04W 56/00

(52) U.S. Cl. CPC H04B 7/06964; H04L 5/0053; H04W 56/0045

(57) ABSTRACT

Various aspects of the present disclosure generally relate to wireless communication. In some aspects, a user equipment (UE) may receive, from a network node associated with a first serving cell, a first beam failure detection reference signal (BFD-RS) set and a second BFD-RS set. The UE may transmit, to a network node associated with a second serving cell associated with multiple timing advance groups (TAGs), based on triggering of beam failure recovery for the first BFD-RS set, a physical uplink control channel (PUCCH) message that carries a link recovery request (LRR) associated with the first BFD-RS set, the PUCCH message being associated with a TAG that is based on one or more of: the second BFD-RS set, a predefined rule, or a TAG or control resource set (CORESET) pool index value associated with the PUCCH message. Numerous other aspects are provided.

### FIELD OF THE DISCLOSURE

Aspects of the present disclosure generally relate to wireless communication and specifically, to techniques and apparatuses associated with a timing advance (TA) determination for a physical uplink control channel (PUCCH) with a link recovery request (LRR).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

When a UE detects a beam failure in a multiple transmission reception point (mTRP) scenario, the UE may transmit a physical uplink control channel (PUCCH) message carrying a link recovery request (LRR) to initiate beam failure recovery (BFR). For example, the PUCCH message may be transmitted using a PUCCH-BFR resource or a PUCCH scheduling request (PUCCH-SR) resource that is configured for the UE. In general, either one or two PUCCH-SR resources may be configured for the UE to transmit the PUCCH message carrying the LRR. For example, in cases where two PUCCH-SR resources are configured, radio resource control (RRC) signaling may configure an association between a beam failure detection reference signal (BFD-RS) set that is used to detect the beam failure on a special cell (SpCell) and the corresponding PUCCH-SR resource. Alternatively, in cases where one PUCCH-SR resource is configured, the UE can transmit the PUCCH with the LRR associated with any BFD-RS set that is configured for the mTRP scenario. However, the different PUCCH-SR configurations may pose challenges with respect to determining a timing advance (TA) that the UE is to apply when transmitting the PUCCH message. For example, multiple TAs may be supported in mTRP operation, whereby two or more TA groups (TAGs) can be configured for a serving cell, which poses challenges with respect to determining which TA or TAG the UE is to use for transmitting a PUCCH message with an LRR. For example, when two PUCCH-SR resources are configured, a PUCCH message with an LRR for a failed BFD-RS set (associated with a failed TRP) is transmitted toward a working TRP, and should therefore be transmitted using a TA or TAG associated with the working TRP despite using a PUCCH-SR resource associated with the failed BFD-RS set that is associated with the failed TRP. Furthermore, when a single PUCCH-SR resource is configured for BFD-RS sets that are associated with different TRPs, the UE could potentially transmit the PUCCH message with the LRR to the working TRP using the TA or TAG associated with the failed TRP.

### SUMMARY

Some aspects described herein relate to a user equipment (UE) for wireless communication. The UE may include at least one memory and at least one processor communicatively coupled with the at least one memory. The at least one processor may be operable to cause the user equipment to receive, from a network node associated with a first serving cell, a first beam failure detection reference signal (BFD-RS) set and a second BFD-RS set. The at least one processor may be configured to cause the user equipment to transmit, to a network node associated with a second serving cell associated with multiple timing advance groups (TAGs), based on one or more measurements of the first BFD-RS set triggering a beam failure recovery for the first BFD-RS set, a physical uplink control channel (PUCCH) message that carries a link recovery request (LRR) associated with the first BFD-RS set, the PUCCH message being associated with a TAG that is based on one or more of the second BFD-RS set, a predefined rule, or a TAG or control resource set (CORESET) pool index value associated with the PUCCH message.

Some aspects described herein relate to a method of wireless communication performed by a UE. The method may include receiving, from a network node associated with a first serving cell, a first BFD-RS set and a second BFD-RS set. The method may include transmitting, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of the second BFD-RS set, a predefined rule, or a TAG or CORESET pool index value associated with the PUCCH message.

Some aspects described herein relate to a non-transitory computer-readable medium that stores a set of instructions for wireless communication by a UE. The set of instructions, when executed by one or more processors of the UE, may cause the UE to receive, from a network node associated with a first serving cell, a first BFD-RS set and a second BFD-RS set. The set of instructions, when executed by one or more processors of the UE, may cause the UE to transmit, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of the second BFD-RS set, a predefined rule, or a TAG or CORESET pool index value associated with the PUCCH message.

Some aspects described herein relate to an apparatus for wireless communication. The apparatus may include means for receiving, from a network node associated with a first serving cell, a first BFD-RS set and a second BFD-RS set. The apparatus may include means for transmitting, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of, the second BFD-RS set, a predefined rule, or a TAG or CORESET pool index value associated with the PUCCH message.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example logical architecture of a distributed radio access network (RAN) in accordance with the present disclosure.

FIG. 5 is a diagram illustrating an example of multiple transmission reception point (mTRP) communication in accordance with the present disclosure.

FIG. 6 is a diagram illustrating an example of transmission reception point (TRP) differentiation at a UE based at least in part on a control resource set (CORESET) pool index in accordance with the present disclosure.

FIG. 7 is a diagram illustrating an example of downlink and uplink transmissions between a network node and a UE based on a timing advance (TA) and/or a guard period in accordance with the present disclosure.

FIG. 8 is a diagram illustrating an example of a beam failure recovery (BFR) procedure in an mTRP communication scenario in accordance with the present disclosure.

FIG. 9 is a diagram illustrating examples of physical uplink control channel (PUCCH) messages carrying a link recovery request (LRR) when multiple TA groups (TAGs) are configured for a component carrier in accordance with the present disclosure.

FIGS. 10A-10B are diagrams illustrating examples associated with a TA determination for a PUCCH with an LRR when multiple PUCCH resources and multiple TAGs are configured on a special cell (SpCell) in accordance with the present disclosure.

FIGS. 11A-11C are diagrams illustrating examples associated with a TA determination for a PUCCH with an LRR when a single PUCCH resource and multiple TAGs are configured on an SpCell in accordance with the present disclosure.

FIG. 12 is a diagram illustrating an example associated with a TA determination for a PUCCH with an LRR when multiple TAGs are configured on a secondary cell (SCell) in accordance with the present disclosure.

FIG. 13 is a flowchart illustrating an example process performed, for example, by a UE in accordance with the present disclosure.

FIG. 14 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to techniques to determine a timing advance (TA) or a TA group (TAG) to associate with a physical uplink control channel (PUCCH) message that carries a link recovery request (LRR) in multiple transmission reception point (mTRP) operation. Some aspects more specifically relate to techniques that may be used to determine the TA or TAG to associate with a PUCCH message that carries an LRR associated with a beam failure that a UE detects associated with a beam failure detection (BFD) reference signal (BFD-RS) set associated with a failed TRP. For example, in cases where BFD-RS sets associated with different TRPs are each associated with a respective PUCCH-SR resource, a PUCCH message that carries an LRR related to a beam failure in a failed BFD-RS set may be associated with a TAG that is associated with a working BFD-RS set that differs from the failed BFD-RS set (for example, based on a (synchronization signal block) SSB group, control resource set (CORESET) pool index value, CORESET pool index configuration, and/or TAG identifier configuration associated with the working BFD-RS set because the LRR is transmitted toward a TRP associated with the working BFD-RS set). Similarly, in cases where BFD-RS sets associated with different TRPs share or are otherwise associated with a single PUCCH-SR resource, a PUCCH message that carries an LRR related to a beam failure in a failed BFD-RS set may be associated with a TAG that is associated with a working BFD-RS set associated with a TRP that the LRR is transmitted toward (for example, based on an SSB group associated with the working BFD-RS set, a CORESET pool index value associated with the working BFD-RS set, or a rule associating a TAG with a BFD-RS set of a working TRP). In addition, some aspects described herein relate to techniques to determine the TA or TAG to associate with a PUCCH message carrying an LRR when a beam failure is detected in a BFD-RS set associated with a special cell (SpCell) and/or a secondary cell (SCell).

Particular aspects of the subject matter described in this disclosure can be implemented to realize one or more of the following potential advantages. In some examples, the described techniques can be used to ensure that a PUCCH message carrying an LRR is transmitted using a TA associated with a TRP that the PUCCH message is transmitted toward. Furthermore, in some examples, the described techniques can ensure that the LRR is transmitted using the TA associated with a TRP that the PUCCH message is transmitted toward in cases where the LRR is transmitted using a PUCCH resource associated with a different TRP (for example, the PUCCH message is transmitted toward a working TRP, using a TA associated with the working TRP and a PUCCH resource associated with a BFD-RS set associated with a failed TRP). Additionally or alternatively, in some examples, the described techniques can ensure that the LRR is transmitted using the TA associated with a TRP that the PUCCH message is transmitted toward in cases where the LRR is transmitted using a PUCCH resource shared by different TRPs. Accordingly, in some examples, the described techniques can ensure that the PUCCH message carrying the LRR is aligned with an internal timing of the working TRP that receives the PUCCH message, which may reduce a probability of uplink transmission and/or uplink reception errors, which may reduce the latency and increase the reliability associated with recovering from beam failure in mTRP operation.

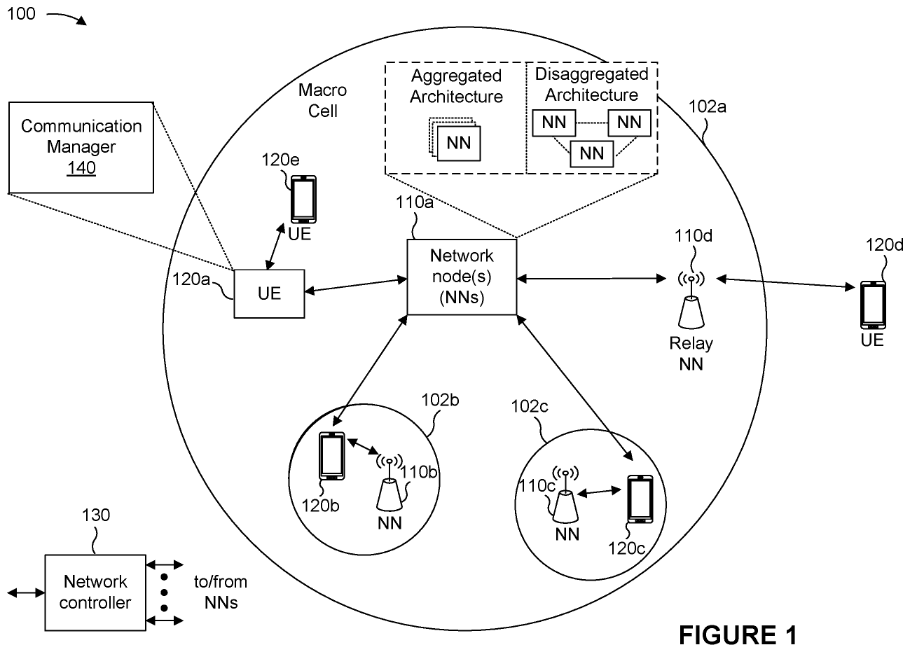

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node associated with a first serving cell, a first BFD-RS set and a second BFD-RS set; and transmit, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of: the second BFD-RS set a predefined rule, or a TAG or a CORESET pool index value associated with the PUCCH message. Additionally or alternatively, the communication manager 140 may perform one or more other operations described herein.

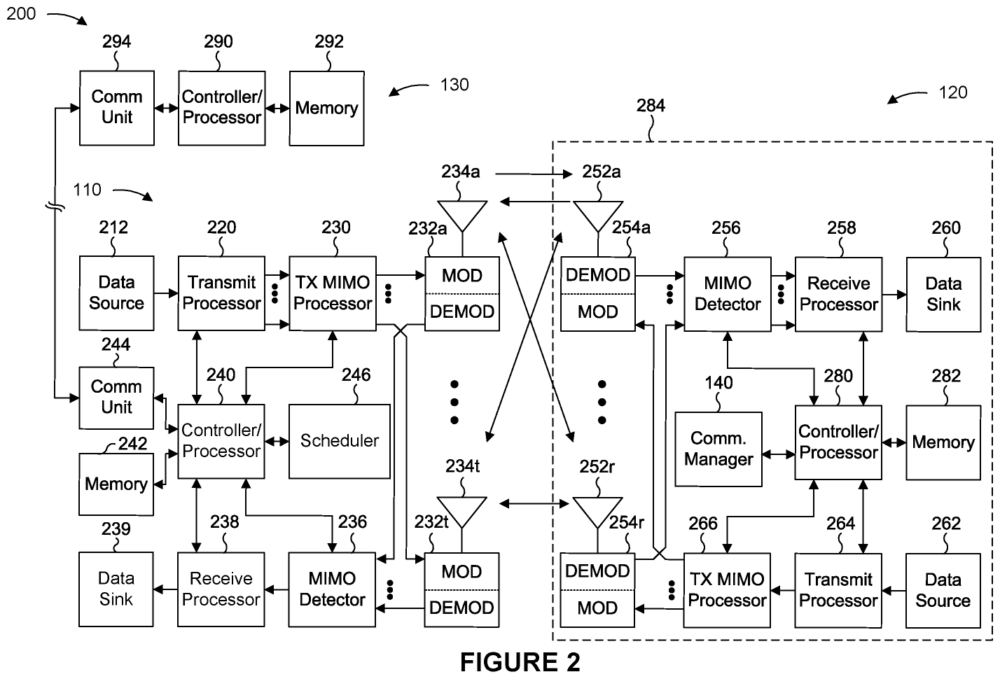

FIG. 2 is a diagram illustrating an example 200 of a network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, Tantennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

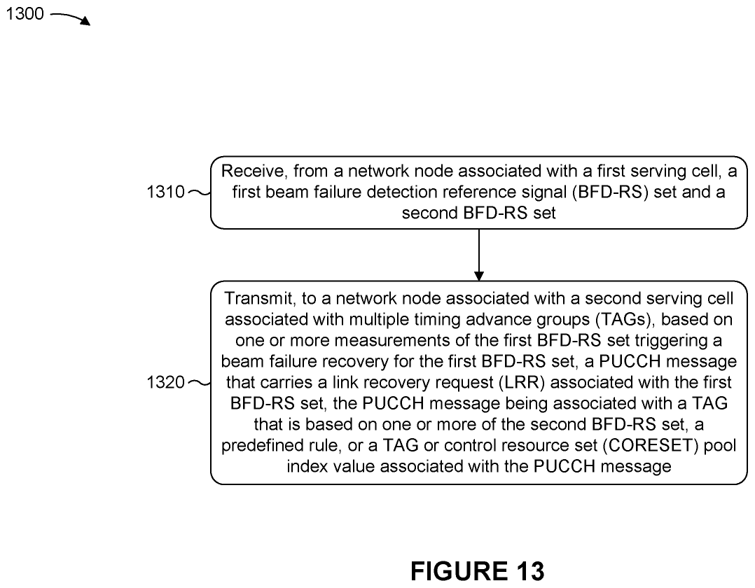

The controller/processor 240 of the network node 110, the controller/processor 280 of the UE 120, or any other component(s) of FIG. 2 may perform one or more techniques associated with a TA determination for a PUCCH with an LRR, as described in more detail elsewhere herein. For example, the controller/processor 240 of the network node 110, the controller/processor 280 of the UE 120, or any other component(s) of FIG. 2 may perform or direct operations of, for example, process 1300 of FIG. 13 or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1300 of FIG. 13 or other processes as described herein. In some examples, executing instructions may include running the instructions, converting the instructions, compiling the instructions, or interpreting the instructions, among other examples.

In some aspects, the UE 120 includes means for receiving, from a network node associated with a first serving cell, a first BFD-RS set and a second BFD-RS set; and/or means for transmitting, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of: the second BFD-RS set, a predefined rule, or a TAG or CORESET pool index value associated with the PUCCH message. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

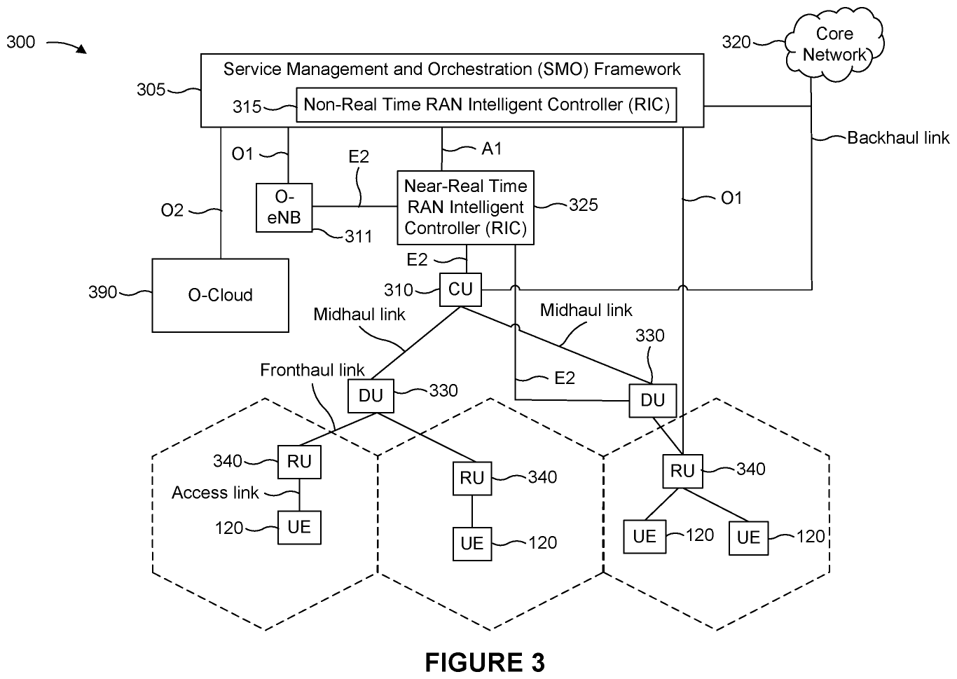

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

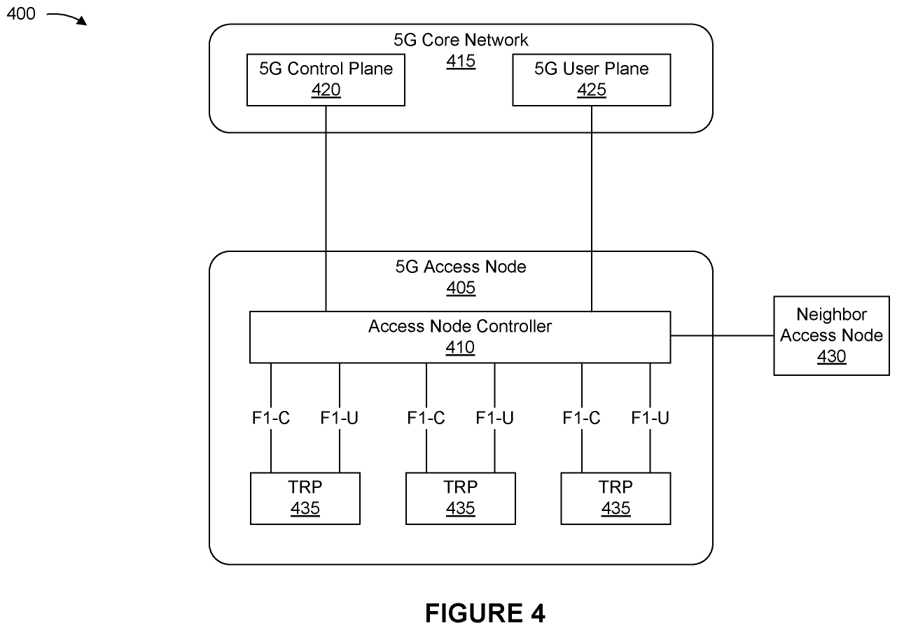

FIG. 4 is a diagram illustrating an example logical architecture of a distributed RAN 400 in accordance with the present disclosure. As shown in FIG. 4, a 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (for example, a 5G gateway), and the backhaul interface for one or both of the 5G control plane and the 5G user plane may terminate at the access node controller 410. Additionally or alternatively, a backhaul interface to one or more neighbor access nodes 430 (for example, another 5G access node 405 and/or an LTE access node) may terminate at the access node controller 410.

The access node controller 410 may include and/or may communicate with one or more TRPs 435 (for example, via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally or alternatively, multiple TRPs 435 may be included in a single network node 110. In some aspects, a network node 110 may include a CU (for example, access node controller 410) and/or one or more DUs (for example, one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a medium access control (MAC) layer may be configured to terminate at the access node controller 410 or at a TRP 435.

In some aspects, multiple TRPs 435 may transmit communications (for example, the same communication or different communications) in the same transmission time interval (TTI) (for example, a slot, a mini-slot, a subframe, or a symbol) or different TTIs using different quasi co-location (QCL) relationships (for example, different spatial parameters, different transmission configuration indicator (TCI) states, different precoding parameters, and/or different beamforming parameters). In some aspects, a TCI state may be used to indicate one or more QCL relationships. A TRP 435 may be configured to individually (for example, using dynamic selection) or jointly (for example, using joint transmission with one or more other TRPs 435) serve traffic to a UE 120.

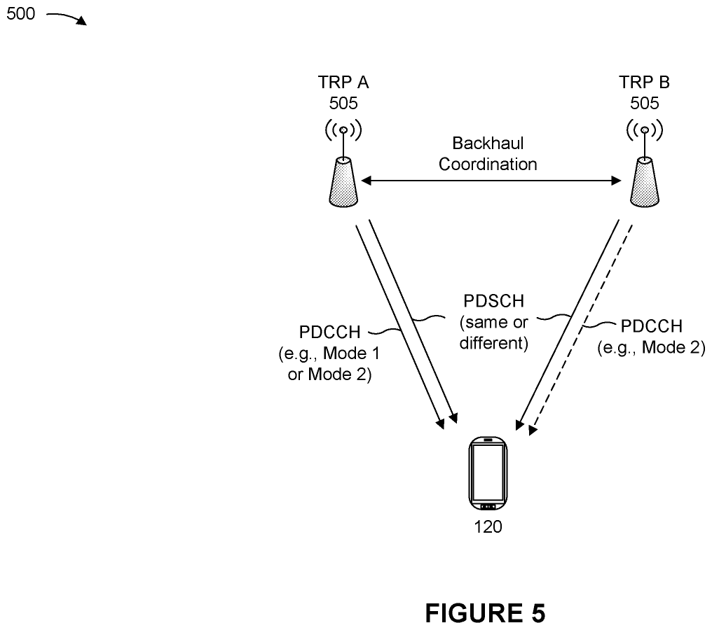

FIG. 5 is a diagram illustrating an example 500 of mTRP communication (sometimes referred to as multi-panel communication) in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (for example, using coordinated multipoint transmissions) to improve reliability and/or increase throughput. The TRPs 505 may coordinate such communications via an interface between the TRPs 505 (for example, a backhaul interface and/or an access node controller 410). The interface may have a smaller delay and/or higher capacity when the TRPs 505 are co-located at the same network node 110 (for example, when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (for example, different TCI states), different DMRS ports, and/or different layers (for example, of a multi-layer communication).

In a first mTRP transmission mode (for example, Mode 1), a single physical downlink control channel (PDCCH) may be used to schedule downlink data communications for a single physical downlink shared channel (PDSCH). In this case, multiple TRPs 505 (for example, TRP A and TRP B) may transmit communications to the UE 120 on the same PDSCH. For example, a communication may be transmitted using a single codeword with different spatial layers for different TRPs 505 (for example, where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (for example, using different sets of layers). In either case, different TRPs 505 may use different QCL relationships (for example, different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (for example, transmitted on the PDCCH, such as DCI format 1_0 or DCI format 1_1) may indicate the first QCL relationship (for example, by indicating a first TCI state) and the second QCL relationship (for example, by indicating a second TCI state). The first and the second TCI states may be indicated using a TCI field in the DCI. In general, the TCI field can indicate a single TCI state (for single-TRP transmission) or multiple TCI states (for mTRP transmission as discussed herein) in this mTRP transmission mode (for example, Mode 1).

In a second mTRP transmission mode (for example, Mode 2), multiple PDCCHs may be used to schedule downlink data communications for multiple corresponding PDSCHs (for example, one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (for example, transmitted by the first TRP 505) may schedule a first PDSCH communication associated with a first set of DMRS ports with a first QCL relationship (for example, indicated by a first TCI state) for the first TRP 505, and second DCI (for example, transmitted by the second TRP 505) may schedule a second PDSCH communication associated with a second set of DMRS ports with a second QCL relationship (for example, indicated by a second TCI state) for the second TRP 505. In this case, DCI (for example, having DCI format 1_0 or DCI format 1_1) may indicate a corresponding TCI state for a TRP 505 corresponding to the DCI. The TCI field of a DCI indicates the corresponding TCI state (for example, the TCI field of the first DCI indicates the first TCI state and the TCI field of the second DCI indicates the second TCI state).

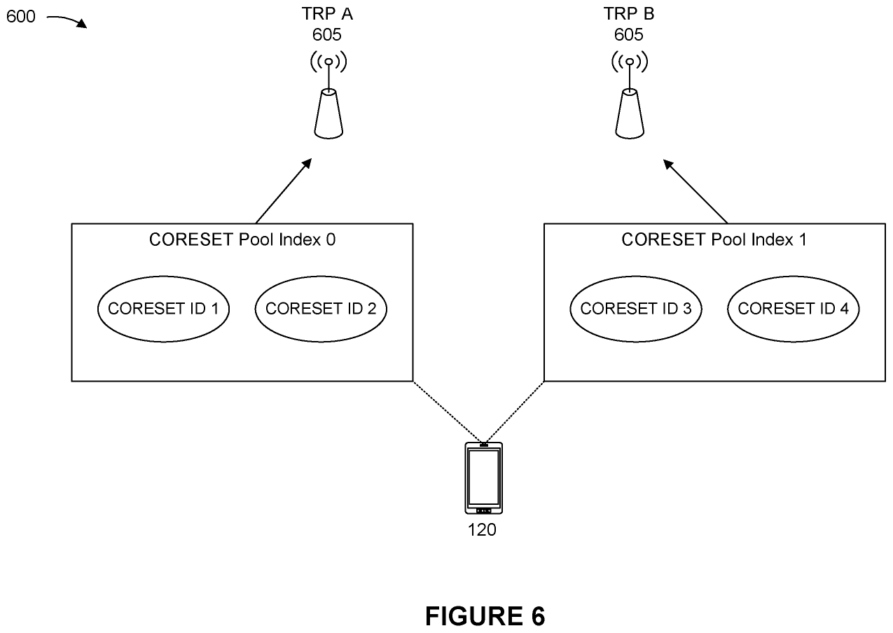

FIG. 6 is a diagram illustrating an example 600 of TRP differentiation at a UE based at least in part on a CORESET pool index in accordance with the present disclosure. In some aspects, a CORESET pool index (or CORESETPoolIndex) value may be used by a UE (for example, a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In an mTRP configuration, each CORESET pool index value may be associated with a particular TRP 605. As an example, and as illustrated in FIG. 6, a first TRP 605 (TRP A) (or a first network node 110) may be associated with CORESET pool index 0 and a second TRP 605 (TRP B) (or a second network node 110) may be associated with CORESET pool index 1. The UE 120 may be configured by a higher layer parameter, such as PDCCH-Config, with information identifying an association between a TRP and a CORESET pool index value assigned to the TRP. Accordingly, the UE 120 may identify the TRP 605 that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP 605 associated with the CORESET pool index value.

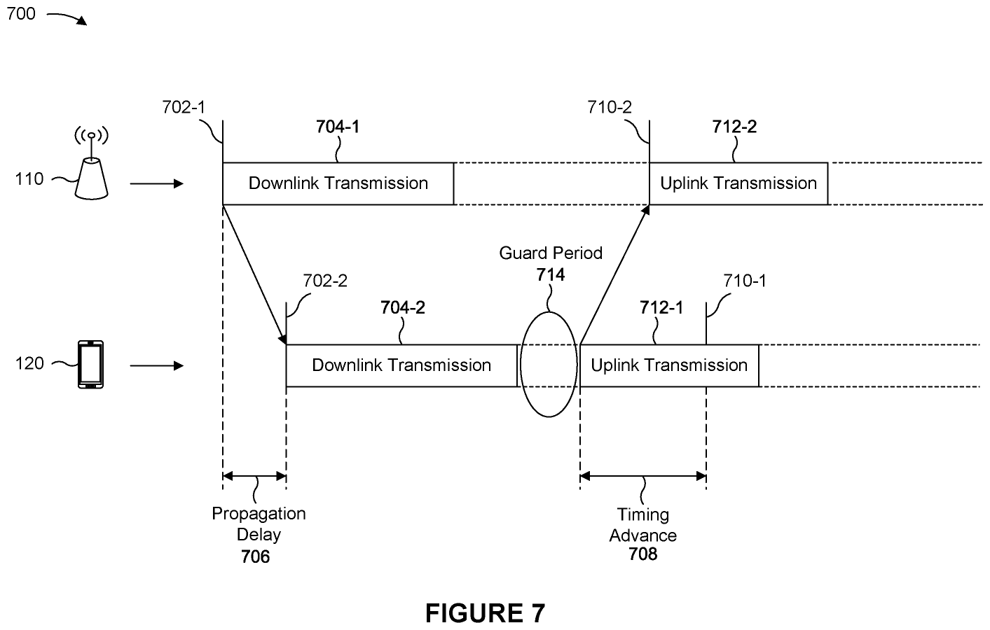

FIG. 7 is a diagram illustrating an example 700 of downlink and uplink transmissions between a network node 110 and a UE 120 based on a TA and/or a guard period between communications in accordance with the present disclosure. As one example, a network node 110 may configure a downlink transmission to end before the start of a guard period. As another example, the UE 120 may advance a start time for an uplink transmission based at least in part on a TA.

As shown by reference number 702-1, a network node 110 may begin a downlink transmission 704-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (for example, 10 milliseconds (msec)). Each radio frame may be further partitioned into a set of Z (Z≥1) subframes, where each subframe may have a predetermined duration (for example, 1 millisecond). Each subframe may be further partitioned into a set of slots and/or each slot may include a set of L symbol periods (for example, fourteen symbol periods, seven symbol periods, or another number of symbol periods). Thus, the first point in time as shown by the reference number 702-1 may be based at least in part on a time partition as defined by a telecommunication system (for example, a frame, a subframe, a slot, a mini-slot, and/or a symbol).

In some examples, the network node 110 and the UE 120 may wirelessly communicate with one another (for example, directly or via one or more network nodes) based at least in part on the defined time partitions. However, each device may have different timing references for the time partitions. To illustrate, and as shown by the reference number 702-1, the network node 110 may begin the downlink transmission 704-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 706 in time, such as a time delay based at least in part on the downlink transmission traveling between a network node 110 (for example, an RU) and the UE 120. As shown by reference number 702-2, the UE 120 may receive downlink transmission 704-2 (corresponding to downlink transmission 704-1 transmitted by the network node 110) at a second point in time that is later in time relative to the first point in time. From a time perspective of the UE 120, however, the UE 120 may associate the second point in physical time shown by the reference number 702-2 with the same particular point in time of the defined time partition as the network node 110 (for example, a beginning of the same symbol, a beginning of the same mini-slot, a beginning of the same slot, a beginning of the same subframe, and/or a beginning of the same frame). Thus, as shown by the example 700, the time perspective of the UE 120 may be delayed in time from the time perspective of the network node 110.

In wireless communication technologies like 4G/LTE and 5G/NR, a TA value is used to control a timing of uplink transmissions by a UE (for example, UE 120) such that the uplink transmissions are received by a network node 110 (for example, an RU) at a time that aligns with an internal timing of the network node 110. A network node 110 may determine the TA value to a UE (for example, directly or via one or more network nodes) by measuring a time difference between reception of uplink transmissions from the UE and a subframe timing used by the network node 110 (for example, by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (for example, located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 710-1, a start of the scheduled point in time may occur at a third physical point in time based at least in part on the timing perspective of the UE 120. However, and as shown by reference number 710-2, the scheduled point in time with reference to the timing perspective of the network node 110 (for example, an RU) may occur at a fourth point in physical time that occurs before the third point in physical time as shown by the reference number 710-1. Accordingly, the network node 110 may instruct the UE 120 (for example, directly or via one or more network nodes) to apply a TA 708 to an uplink transmission to better align reception of the uplink transmission with the timing perspective of the network node 110. However, in some examples, the fourth point in time shown by the reference number 710-2 may occur at or near a same physical point in time as the third point in time shown by the reference number 710-1 such that uplink transmissions from the UE 120 to the network node 110 incur the propagation delay 706. In such a scenario, the network node 110 may instruct the UE 120 to apply a TA with a time duration corresponding to the propagation delay 706.

As shown by the example 700, the UE 120 may adjust a start time of an uplink transmission 712-1 based at least in part on the TA 708 and the start of the scheduled point in time (for example, at the third physical point in time shown by the reference number 710-1). Based at least in part on propagation delay, the network node 110 may receive an uplink transmission 712-2 (corresponding to the uplink transmission 712-1 transmitted by the UE 120) at the fourth point in physical time shown by the reference number 710-2.

In some examples, a TA value may be based at least in part on twice an estimated propagation delay (for example, the propagation delay 706) and/or may be based at least in part on a round trip time (RTT). A network node 110 (for example, a DU or a CU) may estimate the propagation delay and/or select a TA value based at least in part on communications with the UE 120. As one example, the network node 110 may estimate the propagation delay based at least in part on a network access request message from the UE 120. Additionally or alternatively, the network node 110 may estimate and/or select the TA value from a set of fixed TA values.

In some examples, a telecommunication system and/or telecommunication standards may define a guard period 714 (for example, a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 714 may sometimes be referred to as a gap, a switching guard period, or a guard interval.

In some examples, a network node 110 (for example, a DU or a CU) may select a starting transmission time and/or a transmission time duration based at least in part on a receiving device and/or the guard period. For example, the network node 110 may select an amount of content (for example, data and/or control information) to transmit in the downlink transmission 704-1 based at least in part on beginning the transmission at the first point in time shown by the reference number 702-1 and/or the UE 120 completing reception of the downlink transmission 704-2 prior to a starting point of the guard period 714. Alternatively, or additionally, the UE 120 may select an amount of content (for example, data and/or control information) to transmit in the uplink transmission 712-1 based at least in part on the TA 708, the third point in time shown by the reference number 710-1, and/or refraining from beginning the uplink transmission 712-1 until the guard period 714 has ended.

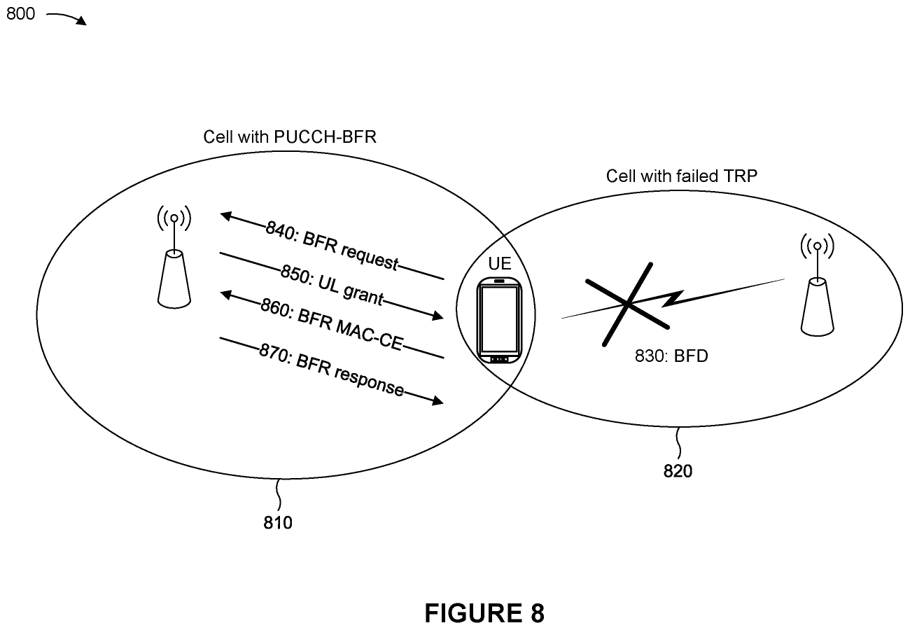

FIG. 8 is a diagram illustrating an example 800 of a beam failure recovery (BFR) procedure in an mTRP communication scenario in accordance with the present disclosure. As shown in FIG. 8, a UE (for example, UE 120) may connect to one or more cells, such as a first TRP and a second TRP in mTRP operation and/or a primary cell (PCell) and an SCell using dual connectivity or carrier aggregation. For example, as described herein, a PCell may be a cell in which the UE either performs an initial connection establishment procedure or initiates a connection re-establishment procedure. For example, the PCell may handle signaling, such as RRC signaling, associated with the UE. In some aspects, the PCell may be a cell indicated as the primary cell during a handover procedure. The PCell may also be referred to as a SpCell. The SCell may be a cell configured to provide additional radio resources to the UE. In some aspects, the PCell and the one or more SCells may each be considered serving cells. In some aspects, a serving cell may be configured with multiple TRPs. In some aspects, one SCell in a set of SCells may also handle signaling associated with the UE, and such an SCell may be referred to as a primary secondary cell (PSCell). A PSCell may be considered an SpCell. Accordingly, an SpCell may refer to a PCell of a master cell group or a PSCell of a secondary cell group. An SpCell is a cell on which a UE can transmit or receive control signaling and/or random access channel messages.

In example 800, the UE is associated with a first cell 810 and a second cell 820. For example, in some aspects, the first cell 810 may be an SpCell (for example, a PCell or a PSCell) and the second cell 820 may be an SCell, or the first cell 810 may be a first SpCell (for example, a PCell), and the second cell 820 may be a second SpCell (for example, a PSCell). In some aspects, the first cell 810 may be in a first frequency range (FR) (for example, FR1), and the second cell 820 may be in a second FR (for example, FR2). In some other aspects, the first cell 810 and the second cell 820 may be in the same FR. In some aspects, the first cell 810 may be provided by a first network node (for example, a first TRP), and the second cell 820 may be provided by a second network node (for example, a second TRP). In some other aspects, the first cell 810 and the second cell 820 may be provided by the same network node (for example, a DU that controls multiple RUs or a CU that controls multiple DUs). In other words, example 800 is an example of a BFR procedure for a first cell 810 and a second cell 820 irrespective of whether the first cell 810 and the second cell 820 are provided by the same network node or different network nodes. Furthermore, although example 800 depicts a BFR procedure where the UE is communicating using multiple cells, it will be appreciated that similar techniques may be applied when the UE experiences beam failure in a single cell scenario (for example, where the UE transmits a BFR request in the serving cell associated with the beam failure, rather than a different serving cell).

As shown in FIG. 8, in a first operation 830, the UE may detect a beam failure associated with a serving cell (for example, the second cell 820 in the illustrated example). For example, the UE may detect that one or more downlink control beams have failed for the second cell 820, such as based at least in part on counting beam failure instances associated with the downlink control beams. Detecting that the one or more downlink control beams have failed may be referred to as beam failure detection (BFD). The UE (for example, a MAC entity of the UE) may be configured, via RRC signaling, to trigger a BFR procedure when BFD occurs. For example, in some aspects, the BFR procedure may be configured per serving cell or per TRP and may be used to indicate, to a serving network node, a new SSB or CSI-RS, such as via candidate beam information, when beam failure is detected on a serving beam (for example, a serving SSB or a serving CSI-RS). For an SpCell BFR, the UE may initiate a random access channel (RACH) procedure for BFR.

In some aspects, to configure BFD per TRP, the UE may be configured with a BFD-RS set, a new beam identification reference signal (NBI-RS) set, and a BFD counter and timer per TRP. For example, in a multi-DCI (mDCI) mTRP scenario, the BFD-RS set associated with a TRP may be implicitly configured, where BFD-RS set k may be derived based on a TCI state associated with a CORESET having a CORESET pool index value of k, where k may have a value of zero (0) or one (1) (for example, the UE may derive BFD-RS set 0 from a TCI state associated with a CORESET associated with CORESET pool index 0, and may derive BFD-RS set 1 from a TCI state associated with a CORESET associated with CORESET pool index 1). Additionally or alternatively, in cases where the number of CORESET TCI states per TRP exceeds a capability of the UE related to the maximum number of BFD-RS resources per set, the UE may implicitly determine the BFD-RS set by reusing a radio link management reference signal (RLM-RS) selection. Alternatively, the BFD-RS set per TRP may be configured explicitly for an mDCI mTRP scenario, where RRC signaling may configure two BFD-RS sets (for example, one BFD-RS set per TRP).

As further shown in FIG. 8, in a second operation 840, the UE may transmit a BFR request (for example, a PUCCH message carrying a scheduling request (SR) or an LRR) on the first cell 810, which is configured with a PUCCH-BFR resource. Alternatively, in some aspects, the BFR request may be transmitted in the second cell 820 associated with the detected beam failure (for example, when there are one or more viable beams available to communicate with the cell associated with the beam failure). For example, up to two (2) PUCCH-BFR resources may be configured per PUCCH group, and the UE may use the PUCCH-BFR resource associated with the failed TRP to transmit the BFR request in cases where there are two PUCCH-BFR resources configured for the PUCCH group (for example, using the PUCCH-BFR resource associated with the BFD-RS set in which beam failure was detected). For example, in cases where two PUCCH-BFR resources are configured, each BFD-RS set may be associated with a respective PUCCH-BFR resource. Alternatively, in cases where only a single PUCCH-BFR resource is configured, the UE may use the configured PUCCH-BFR resource to transmit the BFR request for any failed TRP.

In some aspects, the BFR request, which may be referred to herein as a PUCCH-SR or a PUCCH with an LRR, may request a grant of uplink resources on which the UE can transmit a BFR MAC-CE that carries beam failure information. For example, in some aspects, the beam failure information carried in a BFR MAC-CE may indicate an identifier of the second cell (for example, a failed serving cell instance), an indication of one or more beams that have failed, and/or candidate beam information (for example, information indicating one or more new candidate beams for BFR on the second cell). In some aspects, the UE may monitor one or more control channels after transmitting the BFR request. For example, in a third operation 850, the UE may receive an uplink grant on one or more control channels based at least in part on the BFR request, whereby the UE may monitor the one or more control channels to enable reception of a PDCCH that carries the uplink grant.

As further shown in FIG. 8, in a fourth operation 860, the UE may transmit a BFR MAC-CE after receiving the uplink grant. For example, the UE may transmit the BFR MAC-CE on an uplink resource indicated by the uplink grant. In some aspects, the UE may transmit the BFR MAC-CE based at least in part on evaluation of candidate beams for the second cell 820. For example, if the UE determines that at least one BFR has been triggered and not cancelled for a serving cell for which evaluation of candidate beams has been completed, and if uplink shared channel (UL-SCH) resources are available for a new transmission and if the UL-SCH resources can accommodate the BFR MAC-CE plus a subheader of the BFR MAC-CE as a result of logical channel prioritization (LCP), then the UE (for example, via a multiplexing and assembly procedure of the UE) may generate the BFR MAC CE. If the UL-SCH resources cannot accommodate the BFR MAC-CE plus the subheader, UL-SCH resources are available for a new transmission, and the UL-SCH resources can accommodate a truncated BFR MAC-CE plus a subheader of the truncated BFR MAC-CE as a result of LCP, then the UE (for example, via the multiplexing and assembly procedure) may generate the truncated BFR MAC CE. If neither of the above conditions is satisfied, the UE may trigger a scheduling request for BFR for each serving cell for which BFR has been triggered, not cancelled, and for which evaluation of the candidate beams has been completed. All BFRs triggered for a serving cell may be cancelled when a MAC protocol data unit (PDU) is transmitted, and the MAC PDU includes a BFR MAC-CE or a truncated BFR MAC-CE that contains beam failure information of the serving cell associated with the beam failure. In any case, the BFR MAC-CE may carry a BFR request for all TRPs in all component carriers in a cell group, including information to indicate index(es) of the failed BFD-RS set(s) (for example, to indicate the failed TRP link), index(es) of the component carrier(s) containing the failed TRP link, an indicator of whether a new candidate beam is identified in the NBI-RS set associated with the failed BFD-RS set, and/or a resource indicator that represents the new candidate beam (for example, if a new candidate beam is identified in the NBI-RS set).

As further shown in FIG. 8, in a fifth operation 870, the UE may receive a BFR response, which may acknowledge reception of the BFR MAC-CE. In some aspects, the BFR response may include an uplink grant that schedules a new transmission for the same hybrid automatic repeat request (HARQ) identifier as a physical uplink shared channel (PUSCH) message that carried the BFR MAC-CE. Accordingly, in a sixth operation (not explicitly shown in FIG. 8), the UE may then perform a new beam resetting to configure a new beam to use to communicate with the failed TRP. For example, in an mDCI mTRP scenario, the beams of all CORESETs associated with the CORESET pool index of the failed TRP may be reset to the corresponding reported new candidate beam twenty-eight (28) symbols after the UE receives the BFR response.

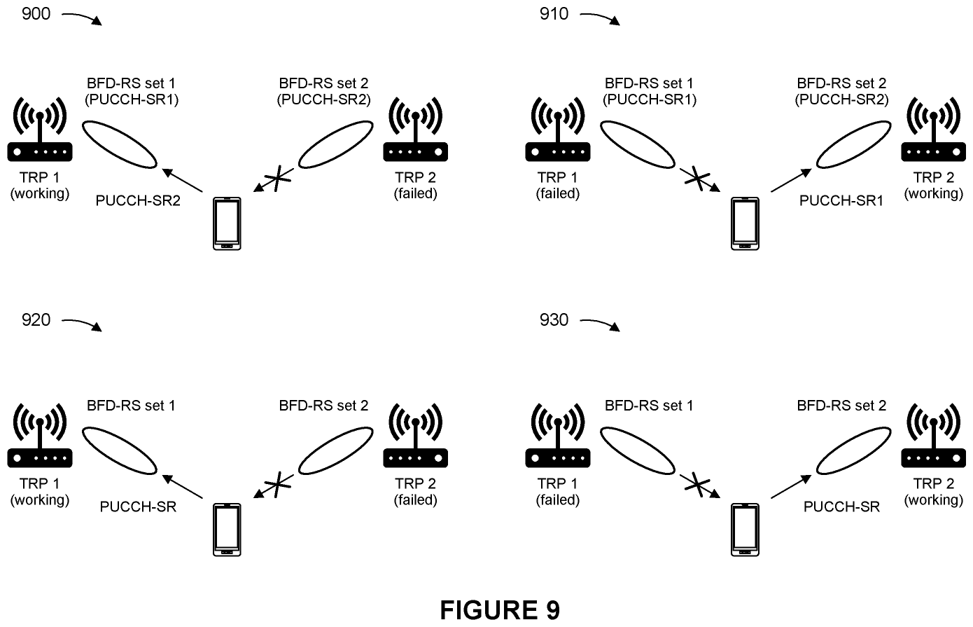

FIG. 9 is a diagram illustrating examples 900, 910, 920, 930 of PUCCH messages carrying an LRR when multiple TAGs are configured for a component carrier in accordance with the present disclosure. As described herein, when a UE detects a beam failure in an mTRP scenario, the UE may transmit a PUCCH message carrying an LRR to initiate a BFR procedure. For example, the PUCCH message may be transmitted using a PUCCH-BFR resource or a PUCCH scheduling request (PUCCH-SR) resource that is configured for the UE. In general, either one or two PUCCH-SR resources may be configured for the UE to transmit the PUCCH message carrying the LRR. For example, in cases where two PUCCH-SR resources are configured in a cell group, RRC signaling may configure an association between a BFD-RS set that is used to detect the beam failure on an SpCell and the corresponding PUCCH-SR resource. For example, the RRC signaling may associate a first BFD-RS set with a first PUCCH-SR resource that may be used to transmit a PUCCH message with an LRR for a first TRP associated with the first BFD-RS set, and may associate a second BFD-RS set with a second PUCCH-SR resource that the UE may use to transmit a PUCCH message with an LRR for a second TRP associated with the second BFD-RS set. Alternatively, in cases where one PUCCH-SR resource is configured in a cell group, the UE can transmit the PUCCH with the LRR associated with either BFD-RS set that is configured for the mTRP scenario. For example, the UE may use the configured PUCCH-SR resource to transmit a PUCCH with an LRR based on detecting a beam failure in a first BFD-RS set associated with a first TRP and/or a beam failure in a second BFD-RS set associated with a second TRP. Furthermore, a PUCCH-SR resource is generally configured only on an SpCell, whereby an association between a BFD-RS set in an SCell and a PUCCH-SR resource to be used to transmit an LRR when a beam failure is detected in the BFD-RS set of the SCell is undefined.

Accordingly, as described herein, the different PUCCH-SR configurations may pose challenges with respect to determining a TA that the UE is to apply when transmitting the PUCCH message with an LRR for a BFD-RS set in which beam failure is detected. For example, because an uplink propagation delay may be different for different TRPs, multiple TAs may be supported in mTRP operation. In such cases, two or more TAGS can be configured for a serving cell, which poses challenges with respect to determining which TA or TAG the UE is to use when transmitting a PUCCH message with an LRR. For example, as described herein, a TA is generally used to control a timing of uplink transmissions by a UE such that the uplink transmissions are received by a network node at a time that aligns with an internal timing of the network node, and a TAG may refer to a group of one or more serving cells that share the same uplink TA.

For example, a wireless network may generally support one or more options to associate TAGs with target uplink channels and/or signals in mDCI mTRP operation. For example, in a first option, each TAG may be associated with a respective TCI state or spatial relation, where a TAG identifier may be configured as part of an uplink TCI state, a joint downlink and uplink TCI state, or an uplink spatial relation. In such cases, when a UE performs an uplink transmission, the UE utilizes the TAG identifier associated with the uplink TCI state, joint downlink and uplink TCI state, or uplink spatial relation to determine the TA to be applied for the uplink transmission. Additionally or alternatively, in a second option, each TAG may be associated with a CORESET pool index. For example, or for a dynamically scheduled or dynamically activated PUSCH transmission, the UE may utilize the TAG associated with the CORESET pool index of the CORESET carrying the PDCCH that dynamically schedules or activates the PUSCH transmission (for example, based on an RRC-configured CORESET pool index for a Type 1 configured grant (CG), a periodic or semi-persistent sounding reference signal (SRS), and/or a periodic or semi-persistent PUCCH). Additionally or alternatively, in a third option, each TAG may be associated with an SSB group, in which case the UE may utilize the TAG associated with the SSB group for an uplink transmission. For example, in cases where a path loss reference signal (PLRS) associated with an uplink transmission is an SSB, the UE may utilize the TAG associated with the SSB group that includes the PLRS associated with the uplink transmission. Alternatively, in cases where the PLRS associated with the uplink transmission is a CSI-RS, the UE may utilize the TAG associated with the SSB group that includes a QCL source SSB of the PLRS. Additionally or alternatively, in a fourth option, the TAG used for dynamically scheduled or dynamically activated uplink channels or uplink signals may be a TAG associated with the CORESET pool index of the CORESET carrying the scheduling PDCCH, and RRC signaling may configure the TAG identifier for periodic or semi-persistent uplink channels and/or signals that are not scheduled or activated by DCI.

Accordingly, when multiple TAGs are configured for a component carrier in mDCI mTRP operation, there are various considerations in determining which TA or TAG a UE should apply to transmit a PUCCH message that carries an LRR. For example, referring to FIG. 9, examples 900 and 910 depict scenarios where two PUCCH-SR resources are configured, where each PUCCH-SR resource is associated with a BFD-RS set associated with a respective TRP. For example, in examples 900 and 910, a first TRP (shown as TRP 1) is associated with a first BFD-RS set (shown as BFD-RS set 1), which is associated with a first PUCCH-SR resource (shown as PUCCH-SR1), and a second TRP (shown as TRP 2) is associated with a second BFD-RS set (shown as BFD-RS set 2), which is associated with a second PUCCH-SR resource (shown as PUCCH-SR2). Accordingly, as shown in example 900, the UE may detect a beam failure in the second BFD-RS set associated with the second TRP, and may transmit a PUCCH message with an LRR toward the (working) first TRP using the second PUCCH resource (PUCCH-SR2) associated with the (failed) second BFD-RS set. Similarly, example 910 depicts a scenario in which the UE detects a beam failure in the first BFD-RS set associated with the first TRP, and transmits a PUCCH message with an LRR toward the (working) second TRP using the first PUCCH resource (PUCCH-SR1) associated with the (failed) first BFD-RS set. In these cases, the PUCCH message that carries the LRR is associated with a beam failure in a BFD-RS set associated with a failed TRP, and should therefore be transmitted toward the working TRP using a TA or TAG associated with the working TRP. However, when two PUCCH-SR resources configured, each BFD-RS set is associated with a respective PUCCH-SR resource for an explicit BFD-RS set configuration or with a respective CORESET pool index value for an implicit BFD-RS set configuration. As a result, the PUCCH message with the LRR for a failed BFD-RS set should be transmitted towards a working TRP using a TA or TAG associated with the working TRP, which is different from the TRP associated with the failed BFD-RS set.

Alternatively, referring to FIG. 9, examples 920 and 930 depict scenarios where one PUCCH-SR resource is configured, where the one PUCCH resource may be used to transmit a PUCCH message with an LRR if a beam failure is detected in any BFD-RS set. For example, in examples 920 and 930, the first TRP is associated with a first BFD-RS set and the second TRP is associated with a second BFD-RS set, where the first and BFD-RS sets are each associated with a single PUCCH-SR resource (shown as PUCCH-SR). Accordingly, as shown in example 920, the UE may detect a beam failure in the second BFD-RS set associated with the second TRP, and may transmit a PUCCH message with an LRR toward the (working) first TRP using the single PUCCH resource (PUCCH-SR). Similarly, example 930 depicts a scenario in which the UE detects a beam failure in the first BFD-RS set associated with the first TRP, and transmits a PUCCH message with an LRR for the first BFD-RS set toward the (working) second TRP using the single PUCCH resource. In these cases, the PUCCH message that carries the LRR is associated with a beam failure in a BFD-RS set associated with a failed TRP, and should therefore be transmitted toward the working TRP using a TA or TAG associated with the working TRP. As a result, because the TRP to receive the PUCCH message with the LRR depends on which BFD-RS set is associated with the beam failure, semi-statically configuring a CORESET pool index or TAG identifier for the PUCCH resource shared by different BFD-RS sets may result in the UE transmitting the PUCCH message using the TA of the failed TRP.

Various aspects relate generally to techniques to determine a TA or a TAG to associate with a PUCCH message that carries an LRR in mTRP operation. Some aspects more specifically relate to techniques that may be used to determine the TA or TAG to associate with a PUCCH message that carries an LRR associated with a beam failure that a UE detects in a BFD-RS set associated with a failed TRP. For example, in cases where BFD-RS sets associated with different TRPs are each associated with a respective PUCCH-SR resource, a PUCCH message that carries an LRR related to a beam failure in a failed BFD-RS set may be associated with a TAG that is associated with a working BFD-RS set that differs from the failed BFD-RS set (for example, based on an SSB group, CORESET pool index value, CORESET pool index configuration, and/or TAG identifier configuration associated with the working BFD-RS set because the LRR is transmitted toward a TRP associated with the working BFD-RS set). Similarly, in cases where BFD-RS sets associated with different TRPs share or are otherwise associated with a single PUCCH-SR resource, a PUCCH message that carries an LRR related to a beam failure in a failed BFD-RS set may be associated with a TAG that is associated with a working BFD-RS set associated with a TRP that the LRR is transmitted toward (for example, based on an SSB group associated with the working BFD-RS set, a CORESET pool index value associated with the working BFD-RS set, or a rule associating a TAG with a BFD-RS set of a working TRP). In addition, some aspects described herein relate to techniques to determine the TA or TAG to associate with a PUCCH message carrying an LRR when a beam failure is detected in a BFD-RS set associated with an SpCell and/or an SCell.

Particular aspects of the subject matter described in this disclosure can be implemented to realize one or more of the following potential advantages. In some examples, the described techniques can be used to ensure that a PUCCH message carrying an LRR is transmitted using a TA associated with a TRP that the PUCCH message is transmitted toward. Furthermore, in some examples, the described techniques can ensure that the LRR is transmitted using the TA associated with a TRP that the PUCCH message is transmitted toward in cases where the LRR is transmitted using a PUCCH resource associated with a different TRP (for example, the PUCCH message is transmitted toward a working TRP, using a TA associated with the working TRP and a PUCCH resource associated with a BFD-RS set associated with a failed TRP). Additionally or alternatively, in some examples, the described techniques can ensure that the LRR is transmitted using the TA associated with a TRP that the PUCCH message is transmitted toward in cases where the LRR is transmitted using a PUCCH resource shared by different TRPs. Accordingly, in some examples, the described techniques can ensure that the PUCCH message carrying the LRR is aligned with an internal timing of the working TRP that receives the PUCCH message, which may reduce a probability of uplink transmission and/or uplink reception errors, which may reduce the latency and increase the reliability associated with recovering from beam failure in mTRP operation.

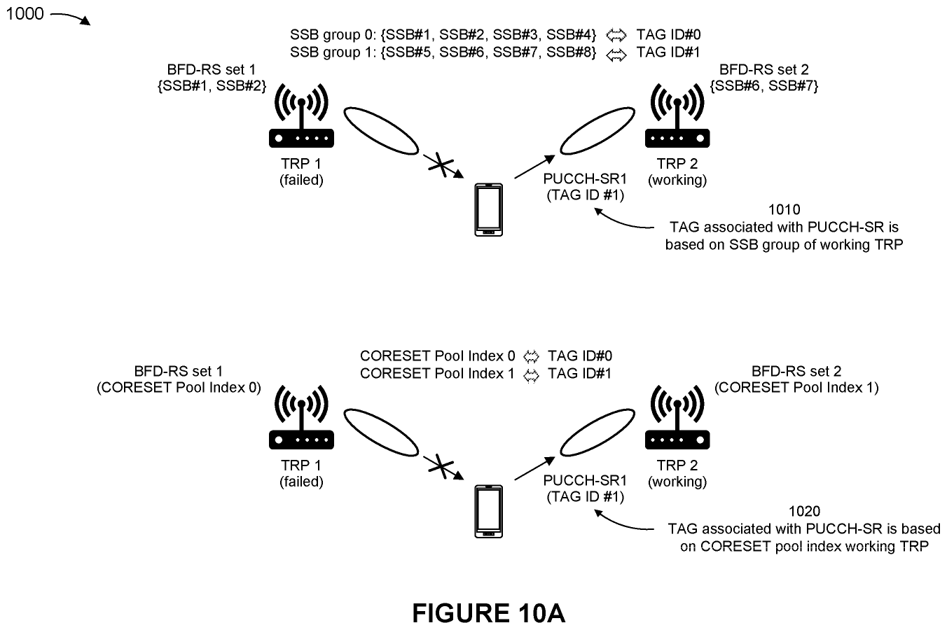

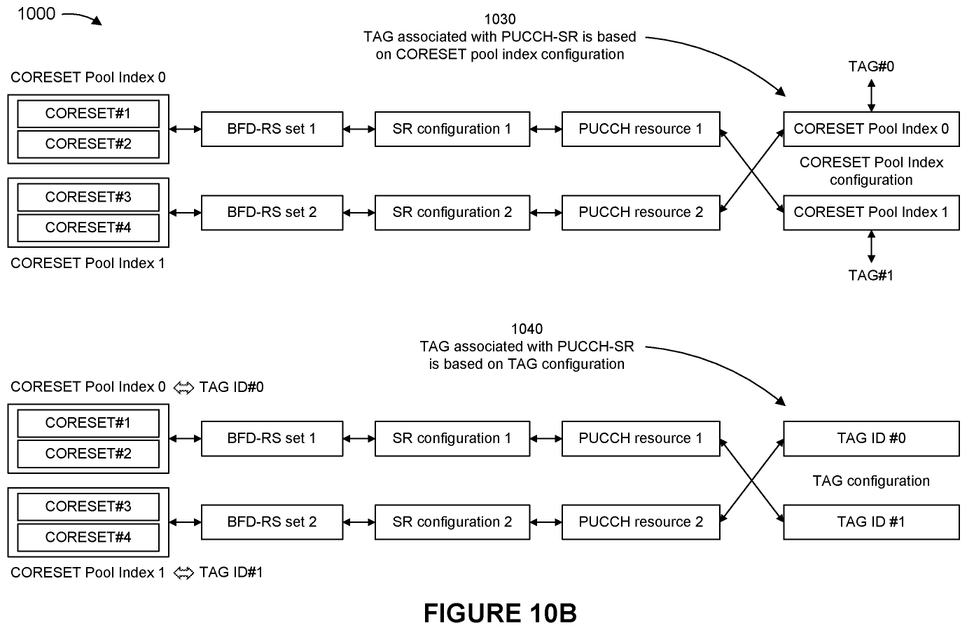

FIGS. 10A-10B are diagrams illustrating examples 1000 associated with a TA determination for a PUCCH with an LRR when multiple PUCCH resources and multiple TAGs are configured on a SpCell in accordance with the present disclosure. As shown in FIG. 10, example 1000 includes communication between a UE (for example, UE 120) and a first TRP (shown as TRP 1) and second TRP (shown as TRP 2) in mTRP operation. In some aspects, the UE, the first TRP, and the second TRP may be included in a wireless network, such as wireless network 100. The UE, the first TRP, and the second TRP may communicate via a wireless access link, which may include an uplink and a downlink.

In some aspects, as described herein, examples 1000 shown in FIGS. 10A-10B relate to mTRP scenarios in which the first TRP and the second TRP are each associated with an SpCell (for example, a PCell or a PSCell), each TRP associated with the SpCell is associated with a respective BFD-RS set, and each BFD-RS set is associated with a respective PUCCH-SR (for example, a PUCCH resource configured for BFR). For example, as shown in FIG. 10A, the first TRP is associated with a first BFD-RS set (shown as BFD-RS set 1), and the second TRP is associated with a second BFD-RS set (shown as BFD-RS set 2). Accordingly, in cases where there are multiple TAGs configured on the SpCell, examples 1000 shown in FIGS. 10A-10B relate to techniques that the UE may use to determine the TAG to associate with a PUCCH message that carries an LRR for a particular BFD-RS set. For example, in some aspects, the UE may receive a BFD-RS set from each TRP, and may trigger a BFR procedure based on one or more measurements associated with the BFD-RS set (for example, as described in further detail above with reference to FIG. 8). For example, in cases where each BFD-RS set is associated with a respective PUCCH-SR resource and a BFR procedure is triggered based on detecting a beam failure for a BFD-RS set, examples 1000 relate to different techniques that may be used to associate a TAG with a PUCCH message that carries an LRR associated with the failed BFD-RS set.

For example, in a first option 1010, each TAG that is configured on the SpCell may be associated with an SSB group, whereby a PUCCH message that carries an LRR for a failed BFD-RS set (for example, a first BFD-RS set) may be associated with the TAG that is associated with the SSB group associated with a working BFD-RS set (for example, a second BFD-RS set). For example, referring to FIG. 10A, a first TAG (shown as TAG ID #0) may be associated with a first SSB group (shown as SSB group 0) that includes SSBs numbered 1 through 4, and a second TAG (shown as TAG ID #1) may be associated with a second SSB group (shown as SSB group 1) that includes SSBs numbered 5 through 8. Accordingly, when the UE triggers a beam failure recovery procedure based on measurements of a failed BFD-RS set, the UE may identify an SSB group associated with the working BFD-RS set, and may associate a PUCCH message transmitted on a PUCCH-SR resource associated with the failed BFD-RS set with a TAG that corresponds to the identified SSB group associated with the working BFD-RS set. For example, in FIG. 10A, the UE may detect a beam failure for the first BFD-RS set associated with the first TRP, where the first BFD-RS set (for example, BFD-RS set 1) is associated with SSBs numbered 1 and 2 in the first SSB group. Accordingly, when the UE transmits a PUCCH message with an LRR for the first BFD-RS set toward the second TRP using the PUCCH-SR resource associated with the first BFD-RS set, using a TA associated with the TAG associated with the second SSB group (for example, the SSB group associated with the BFD-RS set of the working TRP (for example, BFD-RS set 2). On the other hand, if the UE were to detect a beam failure for the second BFD-RS set associated with the second TRP, the PUCCH message with the LRR for the second BFD-RS set would be transmitted toward the first TRP using the PUCCH-SR resource associated with the failed TRP, and using the TAG associated with the first SSB group (for example, the SSB group associated with the BFD-RS set of the first TRP (for example, BFD-RS set 1).

In some aspects, the first option 1010 may be used in cases where two PUCCH-SR resources are configured for BFR in an SpCell, two TAGs are configured on the SpCell, and each TAG is associated with an SSB group. In such cases, a PUCCH message that carries an LRR associated with a first BFD-RS set is associated with the TAG associated with the SSB group that is associated with the second BFD-RS set, which is different than the first BFD-RS set. Similarly, a PUCCH message with an LRR associated with the second BFD-RS set is associated with the TAG associated with the SSB group associated with the first BFD-RS set, which is different than the second BFD-RS set. In other words, when a beam failure is detected in a particular BFD-RS set, the UE may determine the SSB group associated with the working BFD-RS set, and the PUCCH message with the LRR for the failed BFD-RS set is transmitted using the TAG associated with the SSB group associated with the working BFD-RS set. In some aspects, the first option 1010 described herein may be used in cases where the BFD-RS set is explicitly configured (for example, via RRC signaling) or in cases where the BFD-RS set is implicitly configured (for example, based on a TCI state of a CORESET).

Furthermore, the UE may use one or more techniques to determine the SSB group associated with a BFD-RS set. For example, in some aspects, the SSB group associated with a BFD-RS set may be determined based on a BFD-RS in the BFD-RS set with a lowest BFD-RS identifier. In such cases, when the BFD-RS with the lowest identifier is an SSB, the SSB group associated with the BFD-RS set may be an SSB group that includes the first BFD-RS. Alternatively, when the BFD-RS with the lowest identifier is a CSI-RS, the SSB group associated with the BFD-RS set may be an SSB group that includes a QCL source of the BFD-RS with the lowest identifier. In some other aspects, the SSB group associated with a BFD-RS set may be determined based on the first SSB in the BFD-RS set or based on the SSB with the lowest SSB index if at least one SSB is included in in the BFD-RS set. Otherwise, the SSB group may be based on the BFD-RS with lowest identifier if the BFD-RS set does not include any SSBs.

In a second option 1020, each TAG that is configured on the SpCell may be associated with a CORESET pool index value, whereby a PUCCH message that carries an LRR for a failed BFD-RS set may be associated with the TAG that is associated with the CORESET pool index value associated with a working BFD-RS set. For example, in FIG. 10A, a first TAG (shown as TAG ID #0) may be associated with a first CORESET pool index (shown as CORESET pool index 0), and a second TAG (shown as TAG ID #1) may be associated with a second CORESET pool index (shown as CORESET pool index 1). Accordingly, when the UE triggers a beam failure recovery procedure for a failed BFD-RS set, the UE may identify a CORESET pool index value associated with the failed BFD-RS set, and may associate a PUCCH message transmitted on a PUCCH-SR resource associated with the failed BFD-RS set with a TAG that corresponds to the CORESET pool index value of the working BFD-RS set. For example, in FIG. 10B, the UE may detect a beam failure for the first BFD-RS set associated with the first TRP, where the first BFD-RS set is associated with CORESET pool index 0. Accordingly, when the UE transmits a PUCCH message with an LRR for the first BFD-RS set toward the second TRP using the PUCCH-SR resource associated with the first BFD-RS set, the UE associates the PUCCH message with the TAG associated with the CORESET pool index value associated with the working BFD-RS set (for example, the second BFD-RS set). For example, in FIG. 10A, the failed BFD-RS set 1 is associated with a first PUCCH-SR resource (PUCCH-SR1), which is used to transmit the PUCCH message with the LRR for the failed BFD-RS set. Further, the PUCCH message is transmitted toward the second TRP associated with the second BFD-RS set, which is associated with the second CORESET pool index value. Accordingly, in the illustrated example, the PUCCH message is associated with the second TAG associated with the second CORESET pool index value.

In some aspects, in cases where the BFD-RS set associated with each TRP is implicitly determined based on a TCI state of a CORESET, a PUCCH message carrying an LRR associated with a first BFD-RS set is associated with a TAG associated with the CORESET pool index value associated with a second BFD-RS set. Similarly, a PUCCH message carrying an LRR associated with the second BFD-RS set is associated with a TAG associated with the CORESET pool index value associated with the first BFD-RS set. Additionally or alternatively, for an explicitly configured BFD-RS set, a PUCCH message carrying an LRR associated with the first BFD-RS set is associated with the second TAG or CORESET pool index value, and a PUCCH message carrying an LRR associated with the second BFD-RS set is associated with the first TAG or CORESET pool index value (for example, equivalent to assuming that the first BFD-RS set is associated with a first CORESET pool index value and the second BFD-RS set is associated with a second CORESET pool index value for an explicit BFD-RS set).

Referring to FIG. 10B, a third option 1030 is depicted for determining the TAG to associate with a PUCCH message carrying an LRR for a failed BFD-RS set when two PUCCH resources are configured for BFR in the SpCell, which is configured with two TAGs that are each associated with a respective CORESET pool index value. In such cases, where each PUCCH resource is configured with a CORESET pool index value, a PUCCH message carrying an LRR for a failed BFD-RS set is associated with the TAG associated with the configured CORESET pool index value. However, when the TAG associated with the PUCCH message is based on the CORESET pool index configuration, the CORESET pool index value that is configured for a PUCCH message with an LRR associated with a first BFD-RS set is determined based on the CORESET pool index associated with the second BFD-RS set, and vice versa. For example, FIG. 10B illustrates an example where a first BFD-RS set is associated with a first SR configuration for a first PUCCH resource, and a second BFD-RS set is associated with a second SR configuration for a second PUCCH resource. As further shown, the first PUCCH resource is associated with a CORESET pool index value associated with the second BFD-RS set, and the second PUCCH resource is associated with a CORESET pool index value associated with the first BFD-RS set. In other words, the UE generally does not expect to be configured with the same CORESET pool index value associated with a particular BFD-RS set for a PUCCH message with LRR associated with the particular BFD-RS set. Furthermore, for an explicitly configured BFD-RS set, the UE may assume that a first BFD-RS set is associated with a first CORESET pool index value and that a second BFD-RS set is associated with a second CORESET pool index value. For example, a CORESET pool index value of one (1) should be configured for a PUCCH resource to carry an LRR associated with a BFD-RS set associated with a CORESET pool index value of zero (0), and a CORESET pool index value of zero (0) should be configured for a PUCCH resource to carry an LRR associated with a BFD-RS set associated with a CORESET pool index value of one (1).

Still referring to FIG. 10B, a fourth option 1040 is depicted for determining the TAG to associate with a PUCCH message carrying an LRR for a failed BFD-RS set when two PUCCH resources are configured for BFR in the SpCell, which is configured with two TAGs that are each associated with a respective CORESET pool index value. In such cases, where each PUCCH resource is configured with a TAG identifier, a PUCCH message carrying an LRR for a failed BFD-RS set is associated with the TAG identifier configured for the corresponding PUCCH resource. In such cases, when a TAG identifier is configured for a PUCCH resource to carry an LRR for a first BFD-RS set, the configured TAG identifier may be based on the CORESET pool index for a second BFD-RS set, and vice versa. For example, FIG. 10B illustrates an example where a first PUCCH resource is associated with a CORESET pool index value associated with a TAG identifier that is associated with a CORESET pool index associated with a second BFD-RS set. In other words, when transmitting a PUCCH message with an LRR request for a particular BFD-RS set, the UE does not expect the PUCCH resource carrying the LRR request to be configured with the same TAG identifier as the TAG identifier associated with the CORESET pool index value of the particular BFD-RS set. Furthermore, for an explicitly configured BFD-RS set, the UE may assume that a first BFD-RS set is associated with a first CORESET pool index value and that a second BFD-RS set is associated with a second CORESET pool index value.

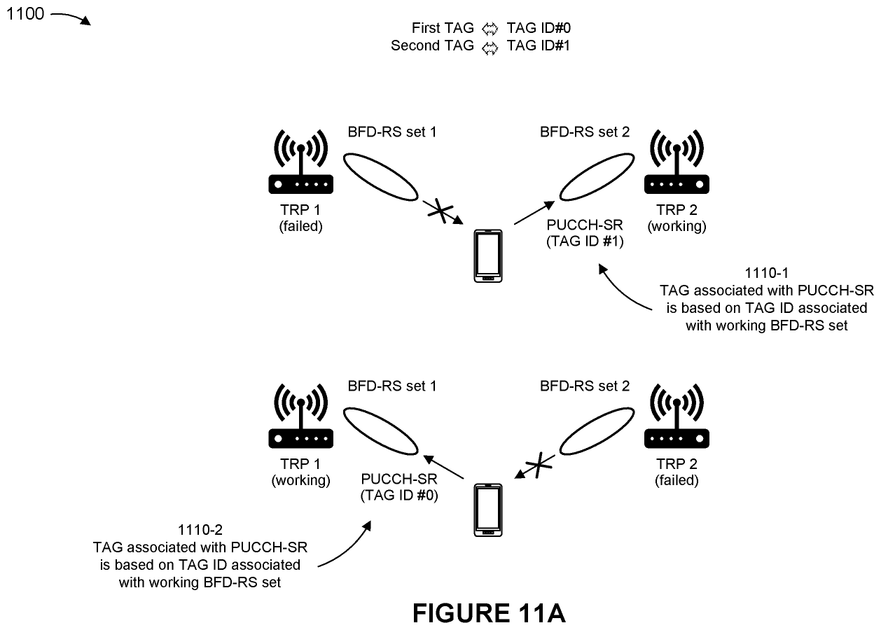

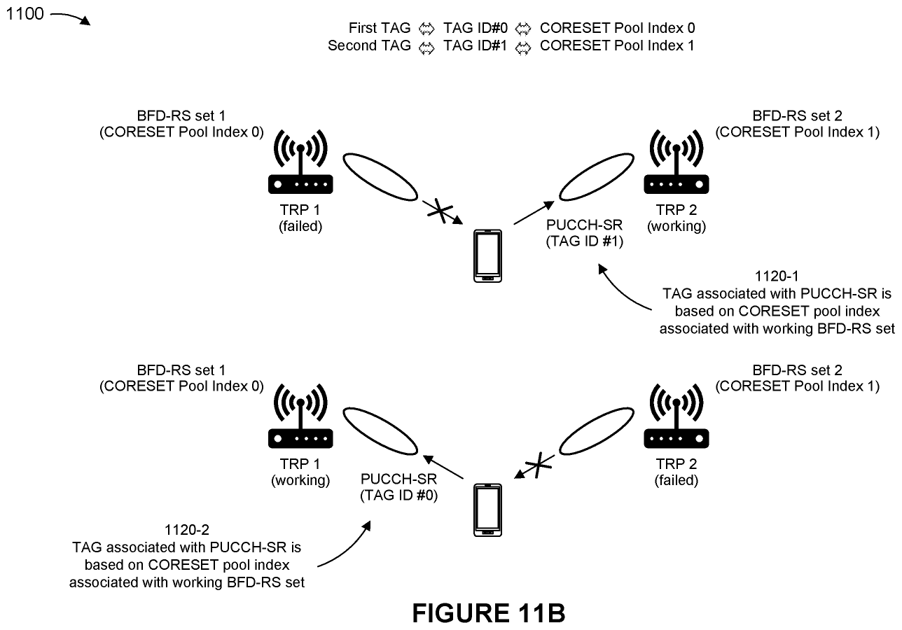

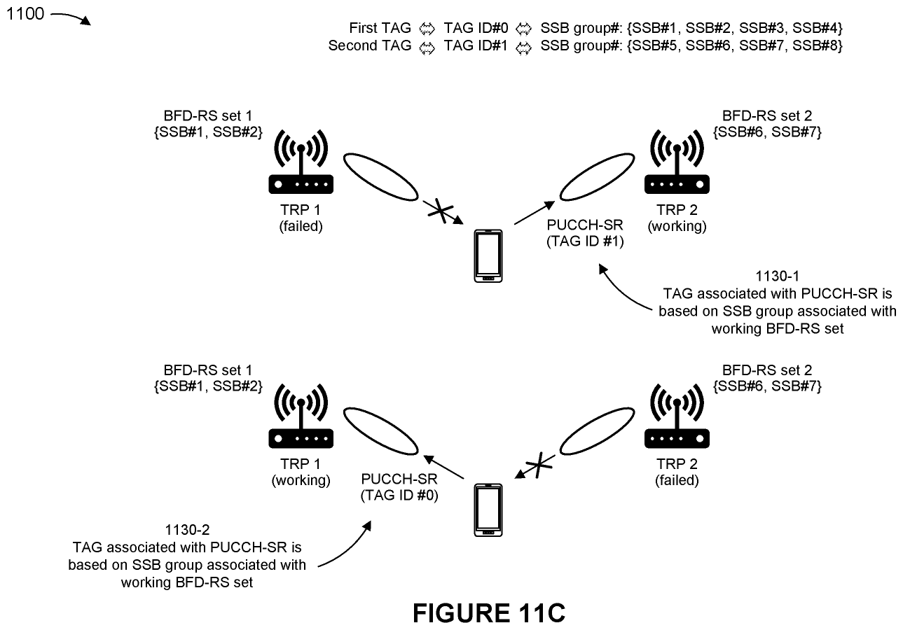

FIGS. 11A-11C are diagrams illustrating examples 1100 associated with a TA determination for a PUCCH with an LRR when a single PUCCH resource and multiple TAGs are configured on a SpCell in accordance with the present disclosure. As shown in FIG. 11, examples 1100 includes communication between a UE (for example, UE 120) and a first TRP (shown as TRP 1) and second TRP (shown as TRP 2) in mTRP operation. In some aspects, the UE, the first TRP, and the second TRP may be included in a wireless network, such as wireless network 100. The UE, the first TRP, and the second TRP may communicate via a wireless access link, which may include an uplink and a downlink.

In some aspects, as described herein, examples 1100 shown in FIGS. 11A-11C relate to mTRP scenarios in which the first TRP and the second TRP are each associated with an SpCell (for example, a PCell or a PSCell), each TRP associated with the SpCell is associated with a respective BFD-RS set, and a single PUCCH-SR resource is configured for the BFD-RS sets associated with both TRPs. For example, as shown in FIGS. 11A-11C, the first TRP is associated with a first BFD-RS set (shown as BFD-RS set 1) and the second TRP is associated with a second BFD-RS set (shown as BFD-RS set 2), and a PUCCH message carrying an LRR for a failed BFD-RS set is transmitted on the shared PUCCH-SR resource regardless of which BFD-RS set has failed. Accordingly, in cases where there are multiple TAGs configured on the SpCell and only one PUCCH-SR resource configured for BFR, examples 1100 shown in FIGS. 11A-11C relate to techniques that the UE may use to determine the TAG to associate with a PUCCH message that carries an LRR for a failed BFD-RS set. For example, in some aspects, the UE may receive a BFD-RS set from each TRP, and may trigger a BFR procedure based on one or more measurements associated with the BFD-RS set (for example, as described in further detail above with reference to FIG. 8).

As shown in FIG. 11A, in a first option 1110, the TAG associated with a PUCCH message transmitted on the shared PUCCH-SR resource is based on a fixed rule, where the PUCCH message is associated with a TAG identifier associated with a working BFD-RS set. For example, as shown in FIG. 11A, a first BFD-RS may be associated with first tag identifier (shown as TAG ID #0), and a second BFD-RS may be associated with second tag identifier (shown as TAG ID #1). Accordingly, in a first example 1110-1, the UE may detect a beam failure for the first BFD-RS set associated with the first TRP, and may associate the PUCCH message carrying the LRR for the first BFD-RS set with the TAG identifier associated with the second BFD-RS set. Similarly, in a second example 1110-2, the UE may detect a beam failure for the second BFD-RS set associated with the second TRP, and may associate the PUCCH message carrying the LRR for the second BFD-RS set with the TAG identifier associated with the first BFD-RS set. In this way, the PUCCH message carrying the LRR is associated with a TAG that corresponds to the TRP that the PUCCH message is transmitted toward.

Additionally or alternatively, in a second option 1120 shown in FIG. 11B, the TAG associated with a PUCCH message transmitted on the shared PUCCH-SR resource may be based on a CORESET pool index value associated with a non-failed or working BFD-RS set. For example, as shown in FIG. 11B, each TAG may be associated with a CORESET pool index value that may be used to differentiate the first TRP from the second TRP. Accordingly, in a first example 1120-1, the UE may detect a beam failure for the first BFD-RS set associated with the first TRP, and may associate the PUCCH message carrying the LRR for the first BFD-RS set with the TAG identifier associated with the CORESET pool index value associated with the second BFD-RS set. Similarly, in a second example 1120-2, the UE may detect a beam failure for the second BFD-RS set associated with the second TRP, and may associate the PUCCH message carrying the LRR for the second BFD-RS set with the TAG identifier associated with the CORESET pool index associated with the first BFD-RS set. In this way, the PUCCH message carrying the LRR is associated with a TAG that corresponds to the TRP that the PUCCH message is transmitted toward.

Additionally or alternatively, in a third option 1130 shown in FIG. 11C, the TAG associated with a PUCCH message transmitted on the shared PUCCH-SR resource may be based on an SSB group associated with a non-failed or working BFD-RS set. For example, as shown in FIG. 11C, each TAG may be associated with an SSB group that includes one or more SSBs. Accordingly, in a first example 1130-1, the UE may detect a beam failure for the first BFD-RS set associated with the first TRP, and may associate the PUCCH message carrying the LRR for the first BFD-RS set with the TAG identifier associated with the SSB group associated with the second BFD-RS set. Similarly, in a second example 1130-2, the UE may detect a beam failure for the second BFD-RS set associated with the second TRP, and may associate the PUCCH message carrying the LRR for the second BFD-RS set with the TAG identifier associated with the SSB group associated with the first BFD-RS set. In this way, the PUCCH message carrying the LRR is associated with a TAG that corresponds to the TRP that the PUCCH message is transmitted toward. In the third option 1130, the UE may use one or more techniques to determine the SSB group associated with a BFD-RS set. For example, in some aspects, the SSB group associated with a BFD-RS set may be determined based on a BFD-RS in the BFD-RS set with a lowest BFD-RS identifier. In such cases, when the BFD-RS with the lowest identifier is an SSB, the SSB group associated with the BFD-RS set may be an SSB group that includes the first BFD-RS. Alternatively, when the BFD-RS with the lowest identifier is a CSI-RS, the SSB group associated with the BFD-RS set may be an SSB group that includes a QCL source of the BFD-RS with the lowest identifier. In some other aspects, the SSB group associated with a BFD-RS set may be determined based on the first SSB in the BFD-RS set or based on the SSB with the lowest SSB index if at least one SSB is included in in the BFD-RS set. Otherwise, the SSB group may be based on the BFD-RS with lowest identifier if the BFD-RS set does not include any SSBs.

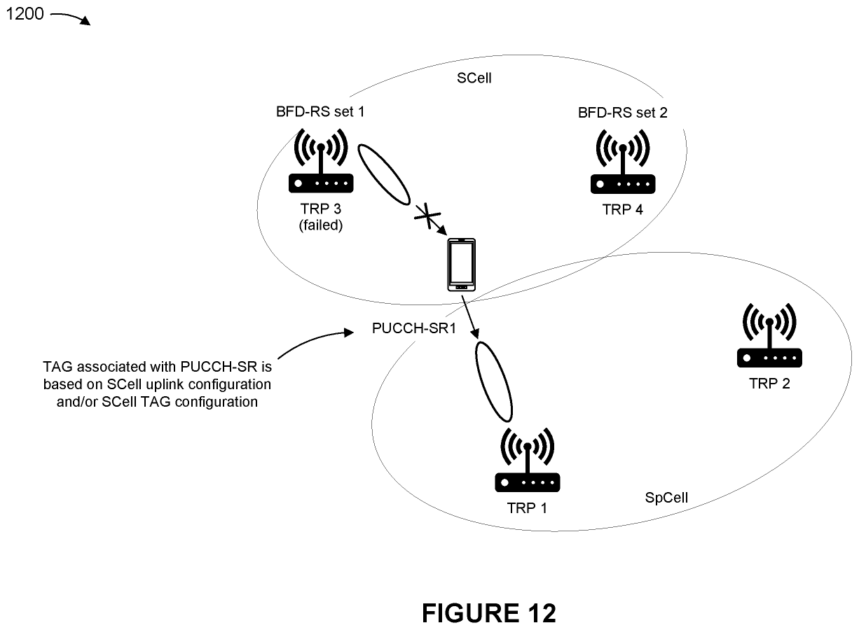

FIG. 12 is a diagram illustrating an example 1200 associated with a TA determination for a PUCCH with an LRR when multiple TAGs are configured on an SCell in accordance with the present disclosure. As shown in FIG. 12, example 1200 includes communication between a UE (for example, UE 120) and various TRPs (shown as TRP 1 through TRP 4) in mTRP operation. In some aspects, the UE and the various TRPs may be included in a wireless network, such as wireless network 100. The UE and the various TRPs may communicate via a wireless access link, which may include an uplink and a downlink.

In some aspects, as described herein, example 1200 shown in FIG. 12 relates to an mTRP scenario in which a BFD-RS set is configured for each TRP in an SCell, and a PUCCH message carrying an LRR for a failed BFD-RS set is transmitted toward a TRP in an SpCell. For example, as shown, the first TRP and the second TRP are each associated with a respective BFD-RS set within an SCell, and the third and fourth TRPs are each associated with an SpCell. As shown in FIG. 12, the TAG that the UE associates with a PUCCH message that carries an LRR for a failed BFD-RS set in the SCell may be based on an uplink configuration and/or a TAG configuration associated with the SCell. For example, in cases where the SCell is associated with an uplink configuration (for example, uplink transmissions are enabled in the SCell) and the SCell is configured with two TAGs that are same as the two TAGs configured for an SpCell, the UE may apply one or more of the options described above with respect to FIGS. 10A-10B and/or FIGS. 11A-11C to determine the applicable TAG to associate with the PUCCH message carrying the LRR. For example, in cases where two PUCCH-SR resources are configured for the SCell, an association between BFR-RS sets on the SCell and the corresponding PUCCH-SR resource may be the same as the association between BFS-RS sets and PUCCH-SR resources in an SpCell. Accordingly, in cases where uplink transmissions are configured in the SCell and the SCell is configured with the same two TAGs as the SpCell, the same or similar techniques that are used to determine the TAG to be used in the SpCell may be used to determine the TAG to associate with a PUCCH message carrying an LRR for a failed BFD-RS set in an SCell.

Alternatively, in cases where the SCell is not associated with an uplink configuration, a single TAG is configured in the SCell, and/or two TAGs are configured in the SCell but the two TAGs are different than the two TAGs configured in the SpCell, the UE may follow an RRC configuration to determine the TAG to associate with a PUCCH message that carries an LRR for a failed BFD-RS set in the SCell. For example, in cases where a TAG identifier or a CORESET pool index value is configured for a PUCCH resource, the RRC configuration may indicate that a PUCCH message triggered by a beam failure associated with a BFD-RS set from the SCell is to be associated with the TAG identifier configured for the PUCCH resource or the CORESET pool index value configured for the PUCCH resource.

FIG. 13 is a flowchart illustrating an example process 1300 performed, for example, by a UE that supports recovering from beam failure in accordance with the present disclosure. Example process 1300 is an example where the UE (for example, UE 120) performs operations associated with a TA determination for a PUCCH message with an LRR.

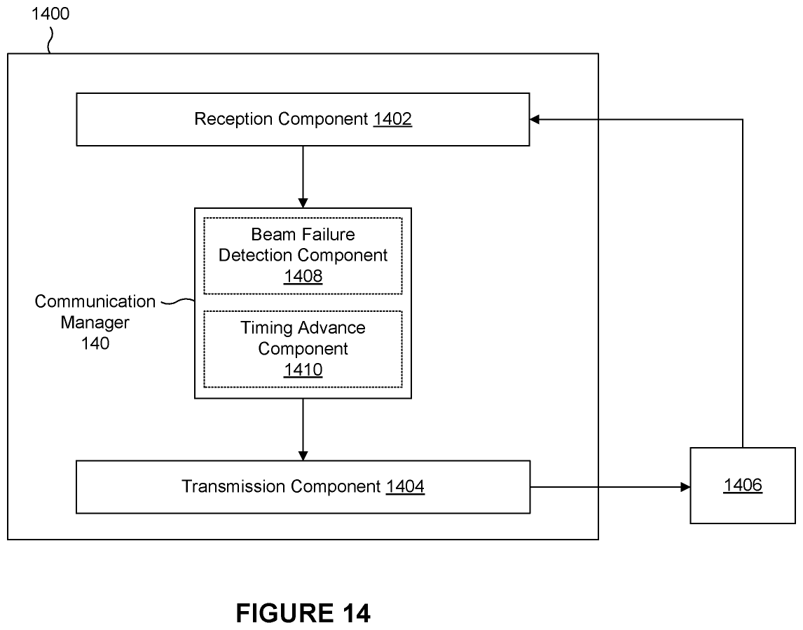

As shown in FIG. 13, in some aspects, process 1300 may include receiving, from a network node associated with a first serving cell, a first BFD-RS set and a second BFD-RS set (block 1310). For example, the UE (such as by using communication manager 140 or reception component 1402, depicted in FIG. 14) may receive, from a network node associated with a first serving cell, a first BFD-RS set and a second BFD-RS set, as described above.

As further shown in FIG. 13, in some aspects, process 1300 may include transmitting, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of: the second BFD-RS set, a predefined rule, or a TAG or CORESET pool index value associated with the PUCCH message (block 1320). For example, the UE (such as by using communication manager 140, beam failure detection component 1408, timing advance component 1410, or transmission component 1404, depicted in FIG. 14) may transmit, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of: the second BFD-RS set, a predefined rule, or a TAG or CORESET pool index value associated with the PUCCH message, as described above.

Process 1300 may include additional aspects, such as any single aspect or any combination of aspects described below or in connection with one or more other processes described elsewhere herein.

In a first additional aspect, the TAG associated with the PUCCH message that carries the LRR associated with the first BFD-RS set is associated with an SSB group associated with the second BFD-RS set.

In a second additional aspect, alone or in combination with the first aspect, the SSB group associated with the second BFD-RS set is based at least in part on a BFD-RS in the second BFD-RS set with a lowest BFD-RS identifier.

In a third additional aspect, alone or in combination with one or more of the first and second aspects, the SSB group associated with the second BFD-RS set is based at least in part on a first SSB in the second BFD-RS set.

In a fourth additional aspect, alone or in combination with one or more of the first through third aspects, the SSB group associated with the second BFD-RS set is based at least in part on an SSB in the second BFD-RS set with a lowest SSB index.

In a fifth additional aspect, alone or in combination with one or more of the first through fourth aspects, the TAG associated with the PUCCH message that carries the LRR associated with the first BFD-RS set is associated with a CORESET pool index value associated with the second BFD-RS set.

In a sixth additional aspect, alone or in combination with one or more of the first through fifth aspects, process 1300 includes receiving a RRC message that indicates a CORESET pool index value for the PUCCH message that carries the LRR associated with the first BFD-RS set, wherein the CORESET pool index is the same as the CORESET pool index value associated with the second BFD-RS set.

In a seventh additional aspect, alone or in combination with one or more of the first through sixth aspects, process 1300 includes receiving a RRC message that indicates a TAG identifier for the PUCCH message that carriers the LRR associated with the first BFD-RS set, wherein the TAG identifier is the same as the TAG identifier associated with the CORESET pool index value associated with the second BFD-RS set.

In an eighth additional aspect, alone or in combination with one or more of the first through seventh aspects, the second serving cell is a SpCell associated with multiple PUCCH resources configured for beam failure recovery, the first serving cell is the same as the second serving cell, and the multiple TAGs are each associated with a respective PUCCH resource among the multiple PUCCH resources configured for beam failure recovery.

In a ninth additional aspect, alone or in combination with one or more of the first through eighth aspects, the predefined rule indicates that the TAG associated with the PUCCH message that carries the LRR associated with the first BFD-RS set is the second TAG of the multiple TAGs.

In a tenth additional aspect, alone or in combination with one or more of the first through ninth aspects, the first BFD-RS set is associated with a first CORESET pool index value, and the predefined rule indicates that the TAG associated with the PUCCH message that carries the LRR associated with the first BFD-RS set is associated with a second CORESET pool index value associated with the second BFD-RS set.

In an eleventh additional aspect, alone or in combination with one or more of the first through tenth aspects, the first BFD-RS set is associated with a first SSB group, and the predefined rule indicates that the TAG associated with the PUCCH message that carries the LRR associated with the first BFD-RS set is associated with a second SSB group associated with the second BFD-RS set.

In a twelfth additional aspect, alone or in combination with one or more of the first through eleventh aspects, the second serving cell is a SpCell associated with a single PUCCH resource configured for beam failure recovery, and the first serving cell is the same as the second serving cell.

In a thirteenth additional aspect, alone or in combination with one or more of the first through twelfth aspects, the first serving cell is an SCell configured with an uplink and associated with multiple TAGs that are the same as the multiple TAGs on the second serving cell, and wherein the second serving cell is a SpCell associated with one or more PUCCH resources configured for beam failure recovery.

In a fourteenth additional aspect, alone or in combination with one or more of the first through thirteenth aspects, the TAG associated with the PUCCH message that carries the LRR associated with the first BFD-RS set is based on a TAG or CORESET pool index value configured for the PUCCH message based on the first serving cell being an SCell configured without an uplink, with a single TAG, or with multiple TAGs that are different than the multiple TAGs on the second serving cell, and based on the second serving cell being a SpCell associated with one or more PUCCH resources configured for beam failure recovery.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a diagram of an example apparatus 1400 for wireless communication that supports recovering from beam failure in accordance with the present disclosure. The apparatus 1400 may be a UE, or a UE may include the apparatus 1400. In some aspects, the apparatus 1400 includes a reception component 1402, a transmission component 1404, and a communication manager 140, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to perform one or more operations described herein in connection with FIGS. 10A-10B, FIGS. 11A-11C, and/or FIG. 12. Additionally or alternatively, the apparatus 1400 may be configured to perform one or more processes described herein, such as process 1300 of FIG. 13. In some aspects, the apparatus 1400 may include one or more components of the UE described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 140. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, and/or a memory of the UE described above in connection with FIG. 2.

The transmission component 1404 may transmit communications, such as reference signals, control information, and/or data communications, to the apparatus 1406. In some aspects, the communication manager 140 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, and/or a memory of the UE described above in connection with FIG. 2. In some aspects, the transmission component 1404 may be co-located with the reception component 1402 in a transceiver.

The communication manager 140 may receive or may cause the reception component 1402 to receive, from a network node associated with a first serving cell, a first BFD-RS set and a second BFD-RS set. The communication manager 140 may transmit or may cause the transmission component 1404 to transmit, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of the second BFD-RS set, a predefined rule, or a TAG or CORESET pool index value associated with the PUCCH message. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a beam failure detection component 1408 and/or a timing advance component 1410. Alternatively, the set of components may be separate and distinct from the communication manager 140. In some aspects, one or more components of the set of components may include or may be implemented within a controller/processor and a memory the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive, from a network node associated with a first serving cell, a first BFD-RS set and a second BFD-RS set. The beam failure detection component may trigger a beam failure recovery for the first BFD-RS set based on one or more measurements of the first BFD-RS set. The transmission component 1404 may transmit, to a network node associated with a second serving cell associated with multiple TAGs, based on the one or more measurements of the first BFD-RS set triggering the beam failure recovery for the first BFD-RS set, a PUCCH message that carries an LRR associated with the first BFD-RS set, the PUCCH message being associated with a TAG. The timing advance component 1410 may determine the TAG to associate with the PUCCH message based on one or more of the second BFD-RS set, a predefined rule, or a TAG or CORESET pool index value associated with the PUCCH message.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

### Aspect 1

A method of wireless communication performed by a UE, comprising: receiving, from a network node associated with a first serving cell, a first BFD-RS set and a second BFD-RS set; and transmitting, to a network node associated with a second serving cell associated with multiple TAGs, based on one or more measurements of the first BFD-RS set triggering a beam failure recovery for the first BFD-RS set, a PUCCH message that carries an LRR associated with the first BFD-RS set, the PUCCH message being associated with a TAG that is based on one or more of: the second BFD-RS set, a predefined rule, or a TAG or CORESET pool index value associated with the PUCCH message.

### Aspect 2

The method of Aspect 1, wherein the TAG associated with the PUCCH message that carries the LRR associated with the first BFD-RS set is associated with an SSB group associated with the second BFD-RS set.

### Aspect 3

The method of Aspect 2, wherein the SSB group associated with the second BFD-RS set is based at least in part on a BFD-RS in the second BFD-RS set with a lowest BFD-RS identifier.

### Aspect 4

The method of any of Aspects 2-3, wherein the SSB group associated with the second BFD-RS set is based at least in part on a first SSB in the second BFD-RS set.

### Aspect 5

The method of any of Aspects 2-4, wherein the SSB group associated with the second BFD-RS set is based at least in part on an SSB in the second BFD-RS set with a lowest SSB index.

### Aspect 6

The method of any of Aspects 1-5, wherein the TAG associated with the PUCCH message that carries the LRR associated with the first BFD-RS set is associated with a CORESET pool index value associated with the second BFD-RS set.

### Aspect 7

The method of any of Aspects 1-6, further comprising: receiving an RRC message that indicates a CORESET pool index value for the PUCCH message that carries the LRR associated with the first BFD-RS set, wherein the CORESET pool index is the same as the CORESET pool index value associated with the second BFD-RS set.

### Aspect 8

The method of any of Aspects 1-7, further comprising: receiving an RRC message that indicates a TAG identifier for the PUCCH message that carriers the LRR associated with the first BFD-RS set, wherein the TAG identifier is the same as the TAG identifier associated with the CORESET pool index value associated with the second BFD-RS set.

### Aspect 9

The method of any of Aspects 1-8, wherein the second serving cell is an SpCell associated with multiple PUCCH resources configured for beam failure recovery, the first serving cell is the same as the second serving cell, and the multiple TAGs are each associated with a respective PUCCH resource among the multiple PUCCH resources configured for beam failure recovery.

### Aspect 10

The method of any of Aspects 1-9, wherein the predefined rule indicates that the TAG associated with the PUCCH message that carries the LRR associated with the first BFD-RS set is the second TAG of the multiple TAGs.

### Aspect 11

The method of any of Aspects 1-10, wherein the first BFD-RS set is associated with a first CORESET pool index value, and wherein the predefined rule indicates that the TAG associated with the PUCCH message that carries the LRR associated with the first BFD-RS set is associated with a second CORESET pool index value associated with the second BFD-RS set.

### Aspect 12

The method of any of Aspects 1-11, wherein the first BFD-RS set is associated with a first SSB group, and the predefined rule indicates that the TAG associated with the PUCCH message that carries the LRR associated with the first BFD-RS set is associated with a second SSB group associated with the second BFD-RS set.

### Aspect 13

The method of any of Aspects 1-12, wherein the second serving cell is a SpCell associated with a single PUCCH resource configured for beam failure recovery, and the first serving cell is the same as the second serving cell.

### Aspect 14

The method of any of Aspects 1-13, wherein the first serving cell is an SCell configured with an uplink and associated with multiple TAGs that are the same as the multiple TAGs on the second serving cell, and wherein the second serving cell is a SpCell associated with one or more PUCCH resources configured for beam failure recovery.

### Aspect 15

The method of any of Aspects 1-14, wherein the TAG associated with the PUCCH message that carries the LRR associated with the first BFD-RS set is based on a TAG or CORESET pool index value configured for the PUCCH message based on the first serving cell being an SCell configured without an uplink, with a single TAG, or with multiple TAGs that are different than the multiple TAGs on the second serving cell, and based on the second serving cell being a SpCell associated with one or more PUCCH resources configured for beam failure recovery.

### Aspect 16

An apparatus for wireless communication at a device, comprising a processor; memory coupled with the processor; and instructions stored in the memory and executable by the processor to cause the apparatus to perform the method of one or more of Aspects 1-15.

### Aspect 17

A device for wireless communication, comprising a memory and one or more processors coupled to the memory, the one or more processors configured to perform the method of one or more of Aspects 1-15.

### Aspect 18

An apparatus for wireless communication, comprising at least one means for performing the method of one or more of Aspects 1-15.

### Aspect 19

A non-transitory computer-readable medium storing code for wireless communication, the code comprising instructions executable by a processor to perform the method of one or more of Aspects 1-15.

### Aspect 20

A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor communicatively coupled with the at least one memory, the at least one processor operable to cause the UE to:
receive, from a network node associated with a first serving cell, a first beam failure detection reference signal (BFD-RS) set and a second BFD-RS set; and
transmit, to a network node associated with a second serving cell associated with multiple timing advance groups (TAGs), based on one or more measurements of the first BFD-RS set triggering a beam failure recovery for the first BFD-RS set, a physical uplink control channel (PUCCH) message that carries a link recovery request (LRR) associated with the first BFD-RS set, the PUCCH message being associated with a TAG that is based on one or more of:
the second BFD-RS set,
a predefined rule, or
a TAG or control resource set (CORESET) pool index value associated with the PUCCH message.

2. The UE of claim 1, wherein the TAG associated with the PUCCH message that carries the LRR associated with the first BFD-RS set is associated with a synchronization signal block (SSB) group associated with the second BFD-RS set.

3. The UE of claim 2, wherein the SSB group associated with the second BFD-RS set is based at least in part on a BFD-RS in the second BFD-RS set with a lowest BFD-RS identifier.

4. The UE of claim 2, wherein the SSB group associated with the second BFD-RS set is based at least in part on a first SSB in the second BFD-RS set.

5. The UE of claim 2, wherein the SSB group associated with the second BFD-RS set is based at least in part on an SSB in the second BFD-RS set with a lowest SSB index.

6. The UE of claim 1, wherein the TAG associated with the PUCCH message that carries the LRR associated with the first BFD-RS set is associated with a CORESET pool index value associated with the second BFD-RS set.

7. The UE of claim 1, wherein the at least one processor is further configured to cause the UE to:
receive a radio resource control message that indicates a CORESET pool index value for the PUCCH message that carries the LRR associated with the first BFD-RS set, wherein the CORESET pool index is the same as the CORESET pool index value associated with the second BFD-RS set.

8. The UE of claim 1, wherein the at least one processor is further configured to cause the UE to:
receive a radio resource control message that indicates a TAG identifier for the PUCCH message that carriers the LRR associated with the first BFD-RS set, wherein the TAG identifier is the same as the TAG identifier associated with the CORESET pool index value associated with the second BFD-RS set.

9. The UE of claim 1, wherein the second serving cell is a special cell (SpCell) associated with multiple PUCCH resources configured for beam failure recovery, the first serving cell is the same as the second serving cell, and the multiple TAGs are each associated with a respective PUCCH resource among the multiple PUCCH resources configured for beam failure recovery.

10. The UE of claim 1, wherein the predefined rule indicates that the TAG associated with the PUCCH message that carries the LRR associated with the first BFD-RS set is the second TAG of the multiple TAGs.

11. The UE of claim 1, wherein the first BFD-RS set is associated with a first CORESET pool index value, and wherein the predefined rule indicates that the TAG associated with the PUCCH message that carries the LRR associated with the first BFD-RS set is associated with a second CORESET pool index value associated with the second BFD-RS set.

12. The UE of claim 1, wherein the first BFD-RS set is associated with a first SSB group, and the predefined rule indicates that the TAG associated with the PUCCH message that carries the LRR associated with the first BFD-RS set is associated with a second SSB group associated with the second BFD-RS set.

13. The UE of claim 1, wherein the second serving cell is a special cell (SpCell) associated with a single PUCCH resource configured for beam failure recovery, and the first serving cell is the same as the second serving cell.

14. The UE of claim 1, wherein the first serving cell is a secondary cell (SCell) configured with an uplink and associated with multiple TAGs that are the same as the multiple TAGs on the second serving cell, and wherein the second serving cell is a special cell (SpCell) associated with one or more PUCCH resources configured for beam failure recovery.

15. The UE of claim 1, wherein the TAG associated with the PUCCH message that carries the LRR associated with the first BFD-RS set is based on a TAG or CORESET pool index value configured for the PUCCH message based on the first serving cell being a secondary cell (SCell) configured without an uplink, with a single TAG, or with multiple TAGs that are different than the multiple TAGs on the second serving cell, and based on the second serving cell being a special cell (SpCell) associated with one or more PUCCH resources configured for beam failure recovery.

16. A method of wireless communication performed by a user equipment (UE), comprising:
receiving, from a network node associated with a first serving cell, a first beam failure detection reference signal (BFD-RS) set and a second BFD-RS set; and
transmitting, to a network node associated with a second serving cell associated with multiple timing advance groups (TAGs), based on one or more measurements of the first BFD-RS set triggering a beam failure recovery for the first BFD-RS set, a physical uplink control channel (PUCCH) message that carries a link recovery request (LRR) associated with the first BFD-RS set, the PUCCH message being associated with a TAG that is based on one or more of:
the second BFD-RS set,
a predefined rule, or
a TAG or control resource set (CORESET) pool index value associated with the PUCCH message.

17. The method of claim 16, wherein the TAG associated with the PUCCH message that carries the LRR associated with the first BFD-RS set is associated with:
a synchronization signal block (SSB) group associated with the second BFD-RS set; or
a CORESET pool index value associated with the second BFD-RS set.

18-21. (canceled)

22. The method of claim 16, further comprising receiving a radio resource control message that indicates:
a CORESET pool index value for the PUCCH message that carries the LRR associated with the first BFD-RS set, wherein the CORESET pool index is the same as the CORESET pool index value associated with the second BFD-RS set; or
a TAG identifier for the PUCCH message that carriers the LRR associated with the first BFD-RS set, wherein the TAG identifier is the same as the TAG identifier associated with the CORESET pool index value associated with the second BFD-RS set.

23. (canceled)

24. The method of claim 16, wherein the second serving cell is a special cell (SpCell) associated with:
multiple PUCCH resources configured for beam failure recovery, the first serving cell is the same as the second serving cell, and the multiple TAGs are each associated with a respective PUCCH resource among the multiple PUCCH resources configured for beam failure recovery; or
a single PUCCH resource configured for beam failure recovery, and the first serving cell is the same as the second serving cell.

25. (canceled)

26. The method of claim 16, wherein the first BFD-RS set is associated with:
a first CORESET pool index value, and wherein the predefined rule indicates that the TAG associated with the PUCCH message that carries the LRR associated with the first BFD-RS set is associated with a second CORESET pool index value associated with the second BFD-RS set; or
a first SSB group, and the predefined rule indicates that the TAG associated with the PUCCH message that carries the LRR associated with the first BFD-RS set is associated with a second SSB group associated with the second BFD-RS set.

27-32. (canceled)
